(19) United States
(12) Patent Application Publication
(10) Pub. No.: US 2013/0284029 A1
(43) Pub. Date: Oct. 31, 2013

(54) COFFEE BREWER ADVERTISING AND MARKETING SYSTEM

(71) Applicants: Larry Reed, Smithtown, NY (US); Manish Dalal, Clifton (IN)

(72) Inventors: Larry Reed, Smithtown, NY (US); Manish Dalal, Clifton (IN)

(21) Appl. No.: 13/873,176

(22) Filed: Apr. 29, 2013

Related U.S. Application Data
(60) Provisional application No. 61/639,475, filed on Apr. 27, 2012.

(51) Int. Cl. G06Q 10/06

(52) U.S. Cl. CPC G06Q 10/067
USPC 99/280; 99/285

(57) ABSTRACT

A coffee brewer advertising and marketing system includes a beverage brewer having a touch-screen display and at least one user-identification sensors, a beverage cup containing a pre-brewed beverage, a brewer lever that is lowered for piercing the beverage cup, and a pre-programmed RFID chip provided on the beverage cup. The beverage brewer has an RF reader that reads the RFID chip embedded on the beverage cup for ensuring that only authorized beverages provided in approved beverage cups are dispensed by the beverage brewer.

### CROSS REFERENCE TO RELATED APPLICATIONS

The present application claims benefit of U.S. Provisional Application Ser. No. 61/639,475, filed Apr. 27, 2012, the disclosure of which is hereby incorporated by reference herein.

### BACKGROUND OF THE INVENTION

1. Field of the Invention

The present invention relates to beverages, and more particularly relates to sales, advertising and marketing systems for beverage machines, such as coffee brewers.

2. Description of the Related Art

A huge global market for coffee products exists. Annual global coffee consumption is 7.4 billion cups. Daily global coffee consumption is 20 million cups. After crude oil, coffee is second top-selling commodity in the world.

The United States ranks 8^{th} in global coffee consumption. Americans drink on average 3.1 cups of coffee daily. Every coffee drinker drinks on average over 1,000 cups annually. The United States coffee market is $18 billion per year.

In an office environment, employees have a limited number of comforts. One comfort that employees desire is coffee or tea. To meet that demand, many employers have an office kitchen in which coffee and/or tea is available.

In the United States, in an office environment, a single serving cup of coffee is about $1.00. According to the website www.coffeemarvel.com, the average employee consumes about three cups of coffee per day.

If a business owner provides coffee for only five employees, the five employees would consume 15 cups of coffee each day. That level of consumption would costs the owner $15 per day, $80 per week, and $4,000 per year.

To limit expenses, some business owners have a “collection jar” for employees to drop in money each time the employee makes a cup of coffee. There are many drawbacks to using a collection jar, however, including employee resentment for feeling nickel and dimed; employees being unable to obtain a cup of coffee because they do not have exact change; employees “borrowing” from the coffee collection jar when they do not have money or exact change; employees refusing to pay; and employees stealing money from the “collection jar.”

Internet retailers have no recurring residual revenue after the sale of certain appliances (e.g., coffee brewers). Often during business transactions, the ownership of a product or service completely transfers from the business owner to the consumer. If there is no service contract associated with the sale, there is no guarantee that the consumer will return or place additional business with the internet retailer.

For example, once a retailer transfers ownership of a consumer product (e.g., a coffee brewer) to a consumer, it is possible the consumer may never return for repeat business, or possibly not return until the life expectancy of the product expires.

Green Mountain Coffee/Keurig addressed this issue, in part, by introducing K-Cups, which only work in Keurig coffee brewers. While this assures Green Mountain of ongoing coffee sales to Keurig customers, the Keurig supplier risks losing customers who no longer wish to continue consuming Green Mountain coffee.

Thus, there remains a need for a coffee brewing system that overcomes the above-described problems and drawbacks of conventional systems and devices.

### SUMMARY OF THE INVENTION

In one embodiment, the present invention discloses a coffee brewer advertising and marketing system and methods that generates revenue from at least four different sources including 1) sales of brewers and pre-brewed beverages to subscribing consumers; 2) advertising sales from subscribing consumers; 3) referral and advertising fees from third party business partners; and 4) pay per click (PPC) advertising fees from third party business partners.

In one embodiment, the present invention preferably includes a website that attracts organizations having any of the following characteristics: 1) The organization wishes to advertise its products and services to targeted business' employees and visitors with specific demographic characteristics (e.g., location, gender, age, etc.); 2) The organization's employees and visitors consume brewed beverages (e.g., coffee, tea, cocoa, etc.); 3) The organization desires its employees to pay for their own office-supplied brewed beverages; and/or 4) The organization has a need for hosted third party Internet business applications (e.g., payroll, employee time and attendance record-keeping, customer relationship management (CRM), sales automation, web conferencing, etc.).

In one embodiment, the system desirably includes a multi-functional beverage brewer with one or more of the following capabilities: 1) The ability to communicate with Hosted Internet sites (e.g., the brewer supplier's website); 2) The ability to display banner ads along with static and streaming multi-media advertising content; 3) The ability to restrict brewer operation to only authorized beverage consumers; and/or 4) The ability to restrict brewer operation to only authorized beverage vendors.

In one embodiment, the coffee brewer advertising and marketing system preferably drives the sale of pre-brewed beverages (e.g., coffee) and brewers to subscribing members. Members will prefer purchasing pre-brewed beverages and brewers because business owners can recuperate $800 per coffee drinker per year. In addition, business owners will have the ability to advertise to neighboring business owners', employees and customers, and business owners can collect advertising fees from neighboring businesses.

In one embodiment, the coffee brewer advertising and marketing system may be operated by using one or more of the following steps: 1) a supplier creates a member website; 2) the supplier invites members to enroll (via e-mail solicitation, newspaper, etc.); 3) members enroll and provide their business profile information; 4) newly enrolled members can then order a b brewer and beverages; 5) the supplier ships the brewer, beverages and related consumables to the member; 6) the member receives and installs the brewer; 7) the member enrolls into the system using the supplier website; 8) the member enrolls their users (e.g., employees) into the system to provide authorization to use the brewer and the system; 9) the member's newly enrolled, installed and programmed brewer dispenses beverages only to the member's enrolled users; 10) the member's newly programmed brewer dispenses beverages only to the supplier's designated beverage vendor; and/or 11) the member returns to the supplier's website when coffee needs to be re-ordered.

In one embodiment, a coffee brewer advertising and marketing system includes a single-serve brewer. The brewer preferably has one or more built-in user identification sensors to ensure that only authorized users can operate the supplier's brewer.

The present invention enables business owners to recuperate up to $800 per employee per year. Moreover, the built-in cup sensor prevents the supplier's brewer from operating if the supplier's coffee brand is not identified. This protects the supplier's coffee revenue since competing coffee brands will not work with the supplier's brewer.

The present invention provides a number of benefits including enabling suppliers to derive revenue from the sale or rental of the supplier's brewers, enabling suppliers to derive on-going revenue from the continuous exclusive sale of the supplier's preferred beverages (e.g., coffee) to the vendor. In one embodiment, the supplier's brewers only work with the supplier's branded beverages. Beverages supplied by competitors will not work with the supplier's brewer; which facilitates the sale of a recession-proof commodity (i.e. coffee), generates recurring protected revenue from coffee sales, and guarantees coffee customers' loyalty and repeat business.

These and other preferred embodiments of the present invention will be described in more detail below.

### BRIEF DESCRIPTION OF THE DRAWINGS

FIG. 1 shows a coffee brewer advertising and marketing system, in accordance with one embodiment of the present invention.

FIGS. 2-11 show a method of using the coffee brewer advertising and marketing system of FIG. 1, in accordance with one embodiment of the present invention.

FIG. 12 shows a coffee brewer advertising and marketing system, in accordance with another embodiment of the present invention

FIGS. 13-26 show screen shots of forms provided on a coffee brewer advertising and marketing system website, in accordance with one embodiment of the present invention.

FIGS. 27A-27F show screen shots of beverage sales forms provided on a coffee brewer advertising and marketing system website, in accordance with one embodiment of the present invention.

FIGS. 28A-28D show screen shots of on-line business referral forms provided on a coffee brewer advertising and marketing system website, in accordance with one embodiment of the present invention.

FIGS. 29A-29E show screen shots of pay per click forms provided on a coffee brewer advertising and marketing system website, in accordance with one embodiment of the present invention.

### DETAILED DESCRIPTION OF PREFERRED EMBODIMENTS

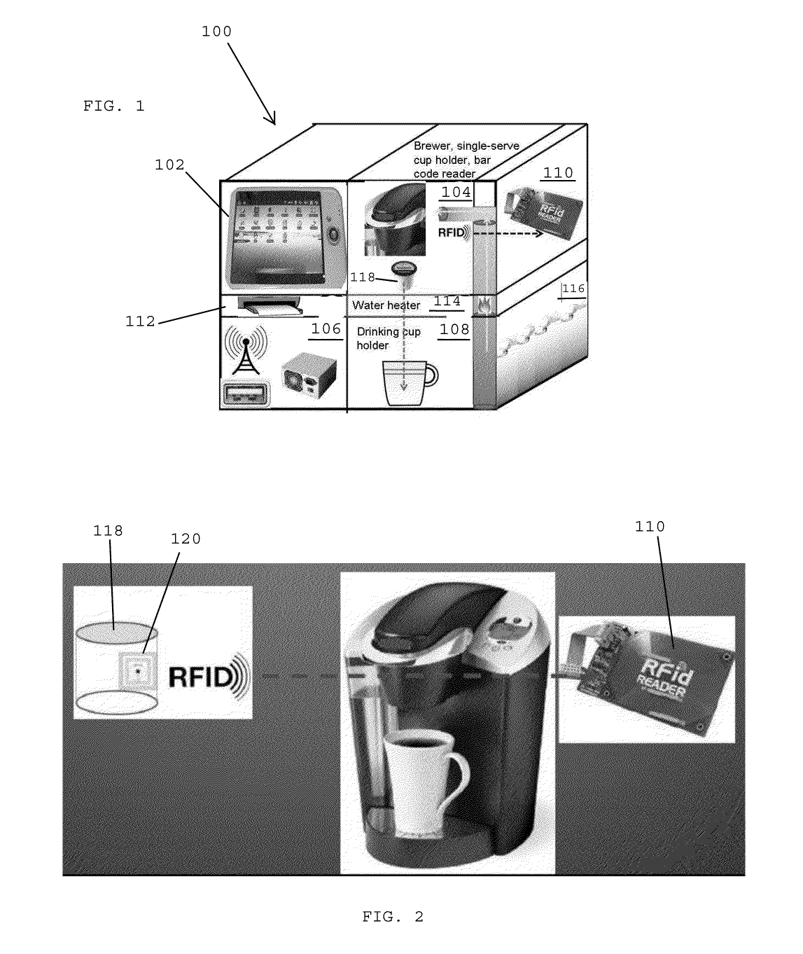

Referring to FIG. 1, in one embodiment, the system preferably includes a beverage brewer 100 including a touch-screen display and multiple user-identification sensors 102. The multiple sensors to identify fingerprints, bar codes, magnetic stripes and proximity cards used by enrolled users to identify themselves. The brewer may have a camera to identify a user's face. In one embodiment, only authorized users may operate the beverage brewer 100. In one embodiment, the beverage brewer 100 preferably includes a brewer lever that, when lowered, pierces a pre-brewed beverage cup/pod and channels water through it for preparing a beverage.

In one embodiment, the brewer lever preferably contains a bar code reader 104 that reads a barcode label printed on the cup/pod. In one embodiment, only authorized beverages in supplier supplied single-serve cups will be dispensed by the brewer.

In one embodiment, the beverage brewer has communication ports 106 including USB, TCP/IP and options for wireless connectivity to an office computer or a cell phone tower. The brewer preferably has a power supply.

In one embodiment, the beverage brewer 100 preferably has a drinking cup holder 108.

In one embodiment, the beverage brewer 100 desirably has a Radio Frequency ID (RFID) reader 110 that recognizes when the supplier's pre-brewed beverage cup having an embedded RFID chip and/or transmitter is being used. The brewer 100 will not operate unless the supplier's beverage cup having an embedded RFID chip is recognized by the RFID reader 110.

In one embodiment, the beverage brewer 100 preferably has a printer for printing usage receipts, vendor coupons and information (e.g., vendor address, phone number, etc.).

In one embodiment, the beverage brewer 100 preferably has a water heater 114 and a water tank 116 for supplying water.

Referring to FIGS. 1 and 2, in one embodiment, the single-serve beverage cup 118 is a small cup or pod that contains a pre-brewed beverage (e.g., coffee) and an embedded pre-programmed RFID chip 120. In one embodiment, the beverage brewer 100 will only dispense coffee if the cup's RFID chip 120 matches the identical RFID electronic signature programmed on the brewer's RFID reader 110. In one embodiment, a barcode may be provided on the cup 118 and the brewer 100 may have a barcode reader rather than the RFID reader 110.

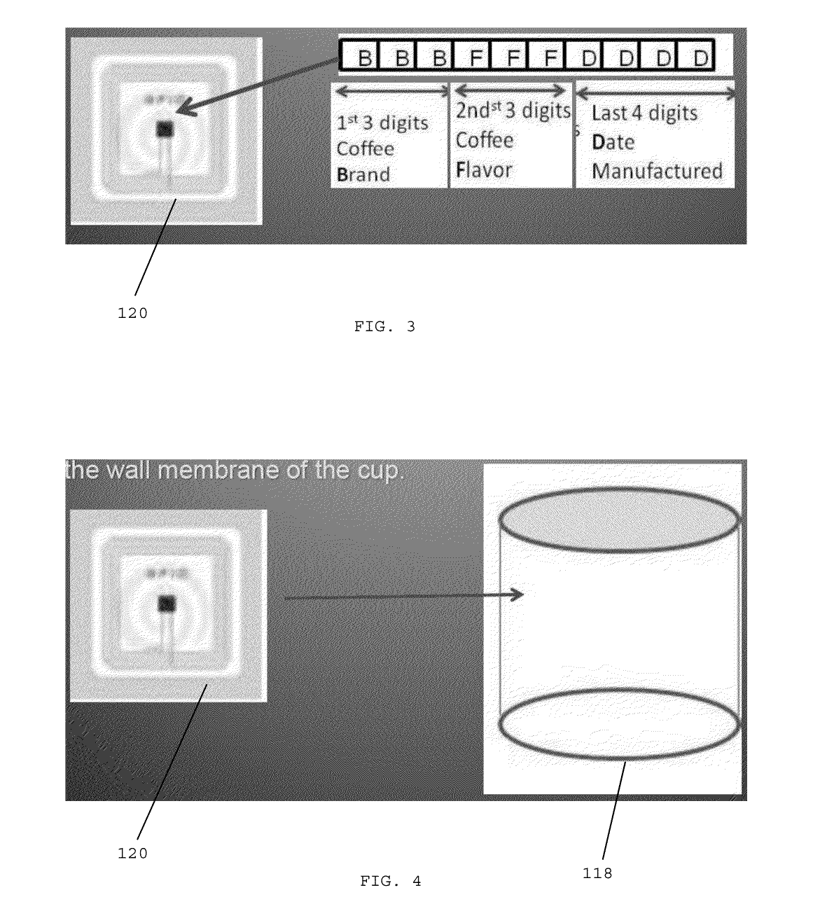

Referring to FIGS. 3 and 4, during manufacture of the cup 118, a pre-programmed RFID chip 120 is programmed with a 10-bit code. The pre-programmed RFID chip 120 with 10-bit code is then embedded into a wall, membrane, or top cover of the cup 118. In one embodiment, the cup's 10-bit code preferably contains 1) the beverage vendor's 3-bit Brand code; 2) a 3-bit flavor code; and 3) a 4-bit date of manufacture code.

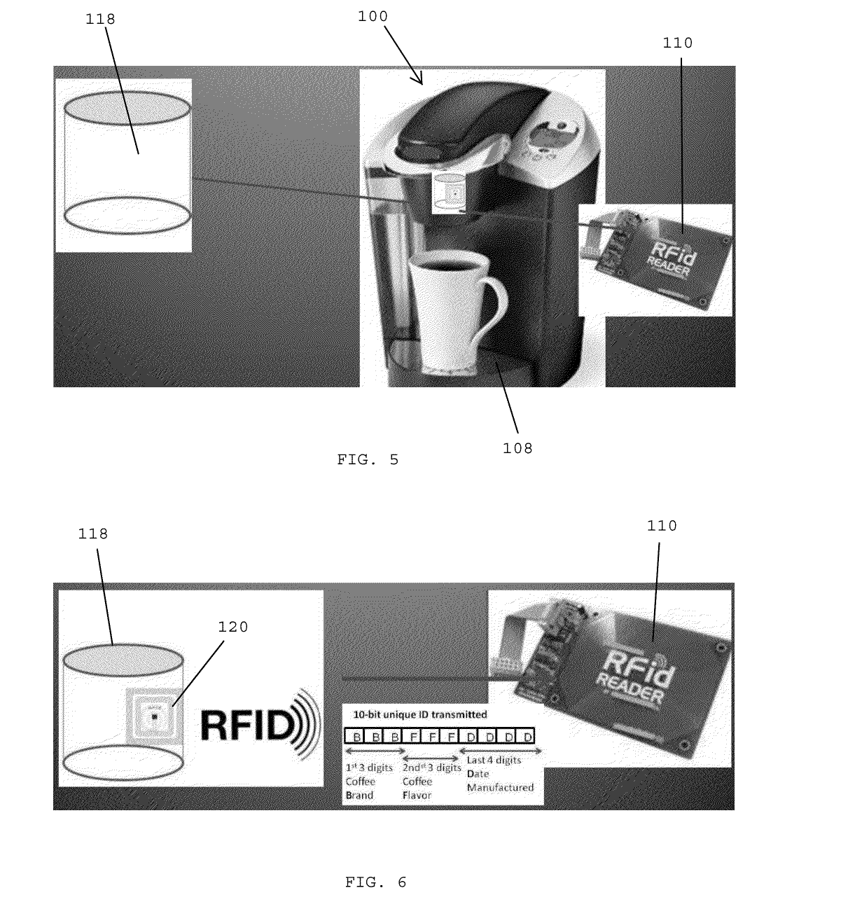

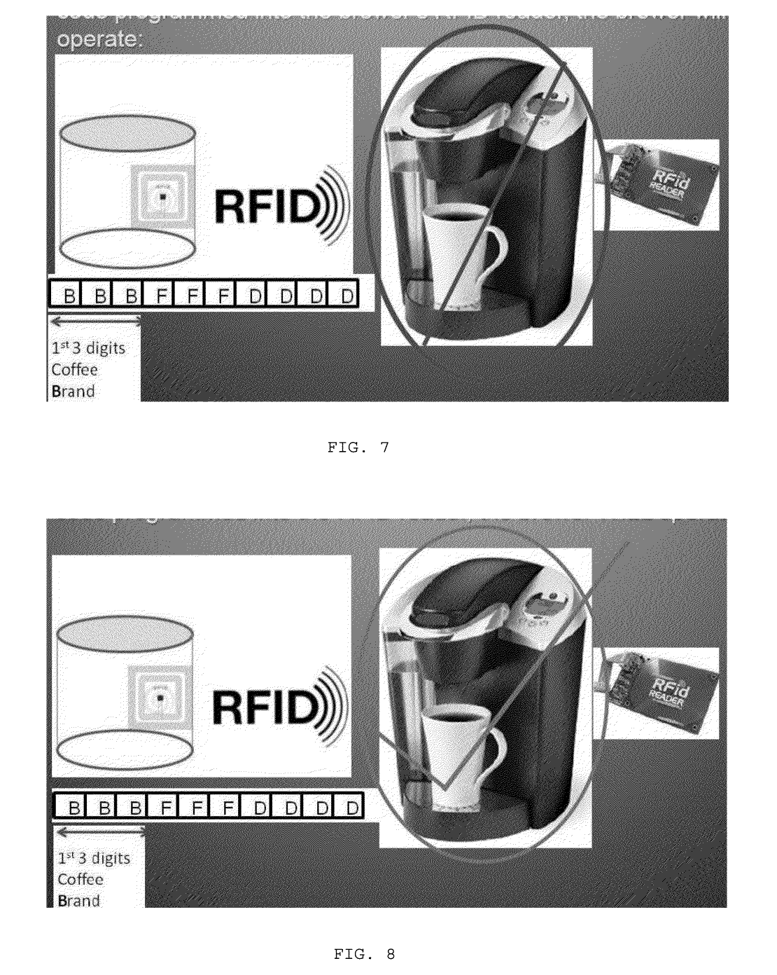

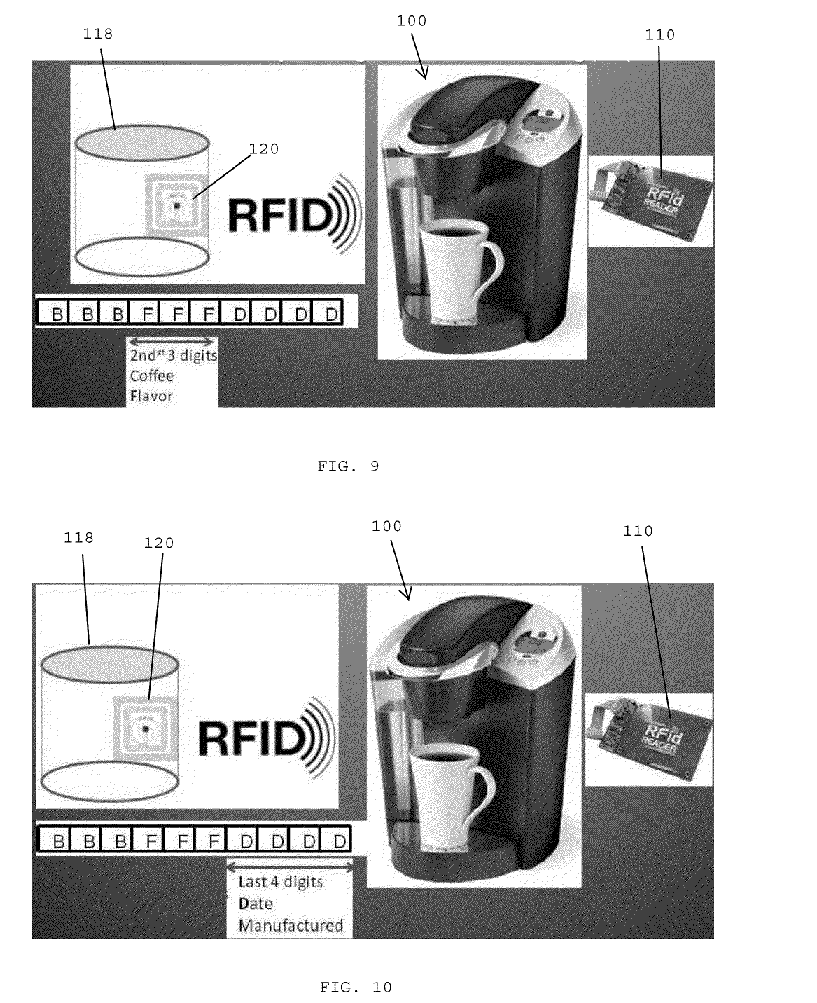

Referring to FIGS. 5 and 6, in one embodiment, the cup 118, when placed inside the cup holder 108 of the beverage brewer 100, transmits the 10-bit code in the RFID chip 120 to the RFID reader 110 located on the beverage brewer 100.

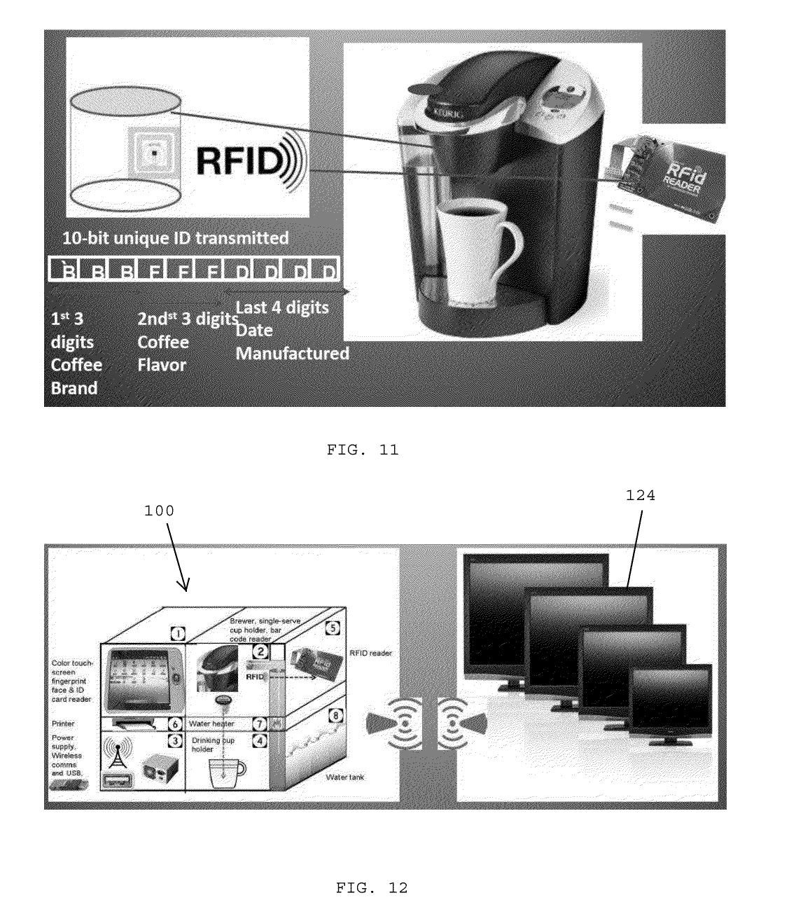

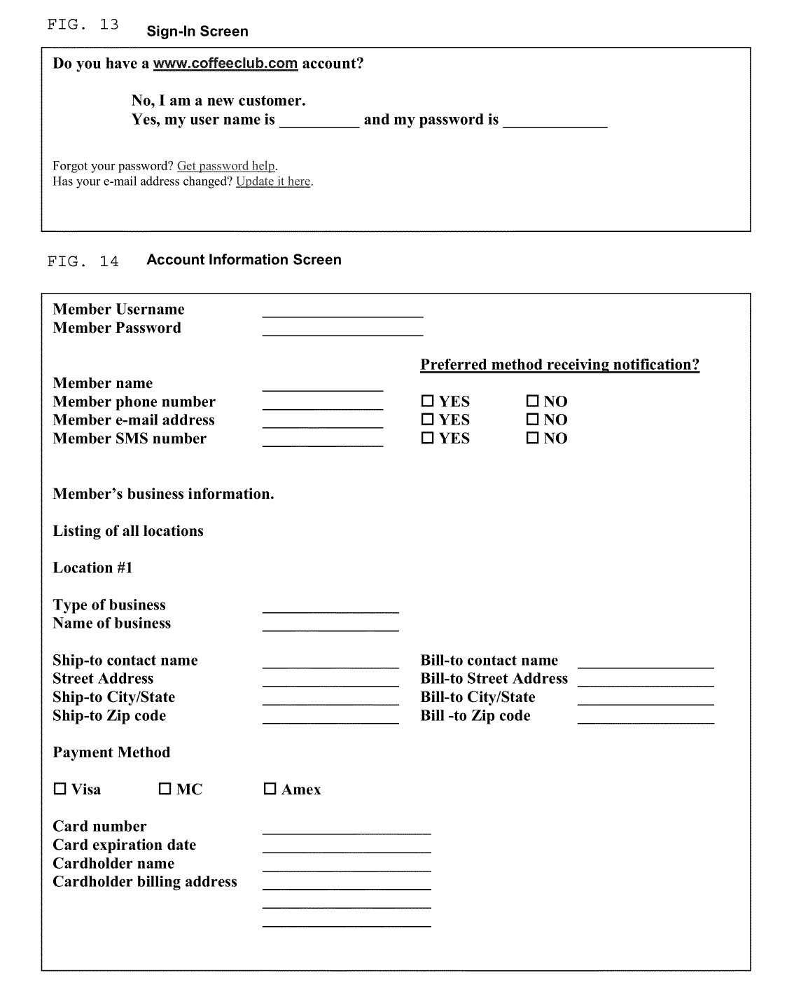

Referring to FIG. 7, if the 3-bit Brand code pre-programmed into the RFID chip on the cup 118 does not match the Brand code programmed into the brewer's RFID reader 110, the brewer 100 will not operate. Referring to FIG. 8, if the 3-bit Brand code pre-programmed into the RFID chip on the cup 118 does match the Brand code programmed into the RFID reader 118, the brewer 100 will operate and brew a beverage.

Referring to FIG. 9, in one embodiment, once the beverage vendor's 3-bit Brand code is verified by the RFID reader 110, the brewer's 100 memory will then preferably record the cup's 3-bit flavor code that has been pre-programmed into the RFID chip 120 on the cup 118. This information can be used for inventory management and/or marketing purposes.

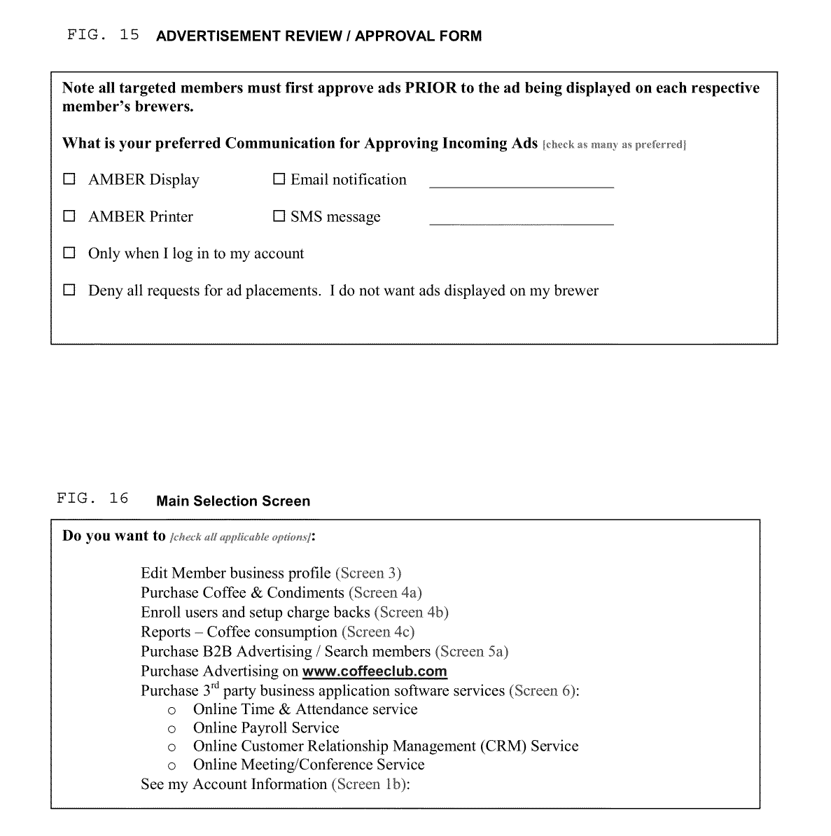

Referring to FIG. 10, in one embodiment, once the beverage vendor's 3-bit Brand code is verified, the brewer's memory will also record the 4-bit date of manufacture that has been pre-programmed into the RFID chip 120 on the cup 118, which preferably ensures that consumers are receiving fresh product.

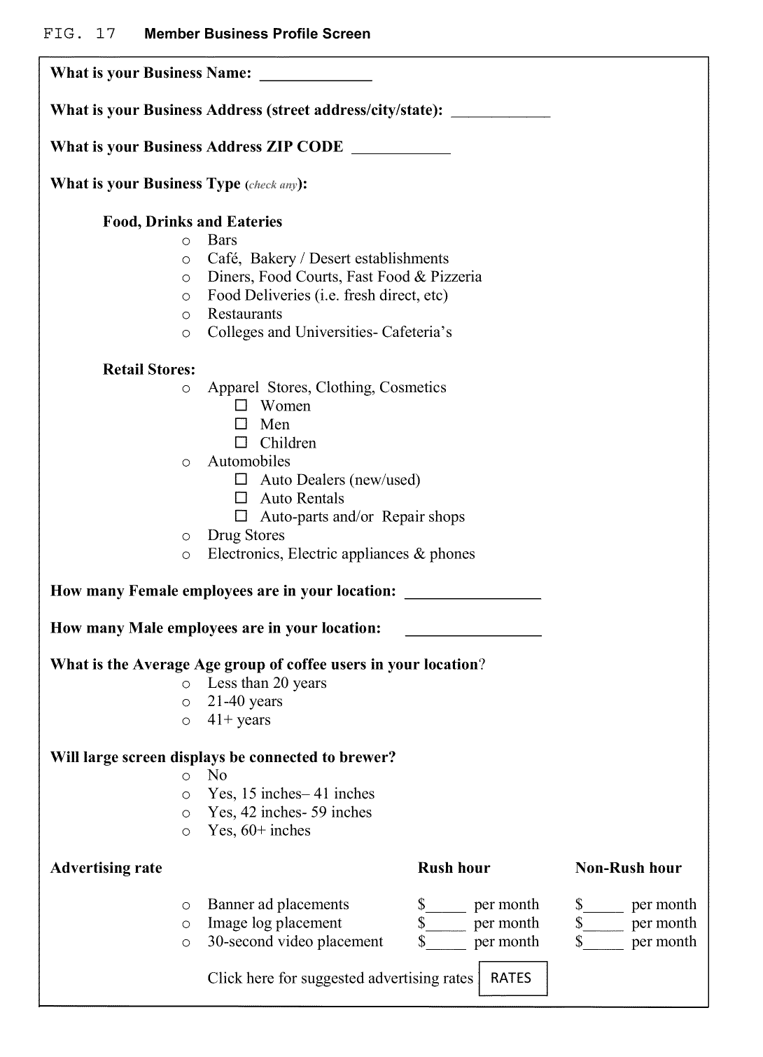

Referring to FIG. 11, in one embodiment, the unique 10-bit RFID tag 120 provides a number of benefits. The 3-bit coffee brand tag ensures that competing coffee cannot be used with the brewer 100. In one embodiment, the brewer 100 will not operate unless a valid RFID tag is recognized on the cup 118. The 3-bit coffee flavor ID allows tracking of a consumer's flavor preferences. The 4-bit manufacturing date ID allows tracking of expiration date, thus ensuring freshness.

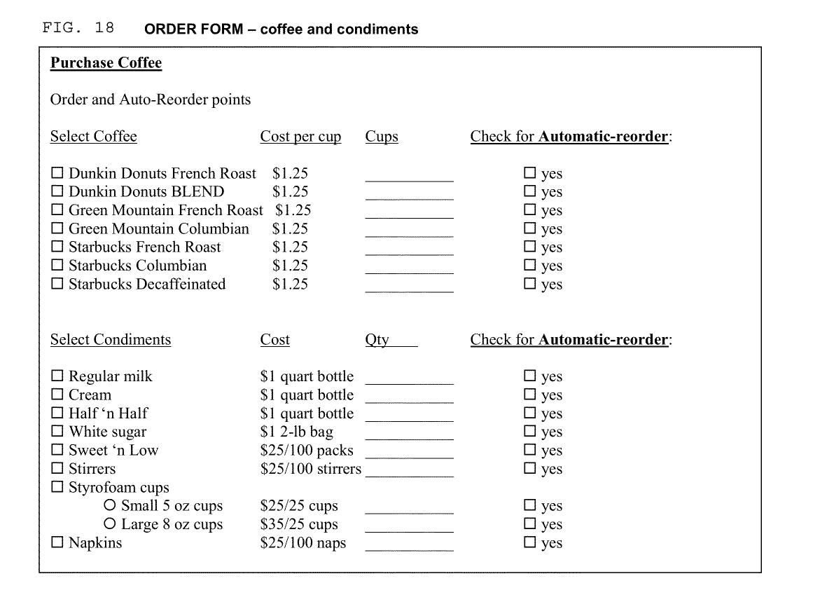

Referring to FIG. 12, members who wish a larger display for advertising content can connect large screen wireless displays 124 to a beverage brewer 100. The larger screen displays 124 may provide an opportunity for generating advertising dollars for entities that place a beverage brewer system in an office environment.

In one embodiment, customers and prospective advertisers may prefer a much larger screen display. Since an integrated screen display-size may be limited by the physical size of the brewer 100. In one embodiment, wireless connectivity to third party large screen displays supporting Wi-Fi is also possible. With larger screen displays, advertisers may be willing to pay higher prices to end-users who will display the prospective advertisers' ads.

In one embodiment, the brewer 100 may serve as an open business application software platform, similar to what is found in conventional smart phones.

In one embodiment, the coffee brewer advertising and marketing system disclosed herein may support one or more of the following third party business applications: Employee Time and Attendance Recording; Health-club membership validation; Food service selection and billing; Health-club class and equipment reservation; Movie theater ticket purchasing; Check Cashing; Movies theatre display trailers/reviews; Child Pick-up; Visitor tracking; Patient Check-in; Point of Sales (POS); and/or Weather updates.

In one embodiment, the coffee brewer advertising and marketing system disclosed herein provides a unique “Advertising Medium and Pre-brewed beverage Re-order system,” which is also referred to by the acronym AMBeR.

In one embodiment, entities that use the coffee brewer advertising and marketing system disclosed herein will be large suppliers of brewers and pre-brewed beverages (and/or related accessories) who wish not only to increase their customer demand for pre-brewed beverages and accessories, but also wish to obtain their customer/organizational demographic profiles (e.g., type of organization, numbers of members/employees, gender of members/employees, age of members/employees and address of each branch/location).

Obtaining these customer/organizational profiles (invention methodology) and providing an advertising medium (invention apparatus/brewer) creates a system which can generate sales from advertising and product sales of brewers, pre-brewed beverages and all associated consumables/condiments. Having customer/organizations' profiles also helps brewer-suppliers to cross-sell other products and services.

The coffee brewer advertising and marketing system disclosed herein may be utilized for providing online business service provider referrals and online business services. According to the Gartner Group, in 2010, the estimated sales from online business services (aka SaaS) reached $10B. Gartner Group estimates that SaaS sales will reach $21.3B by 2015. Customer relationship management (CRM) continues to be the largest market for SaaS, generating sales of $3.2B in 2010.

In one embodiment, the coffee brewer advertising and marketing system disclosed herein entails a methodology and apparatus that when combined helps its adopters generate revenue from four primary sources: 1) Sales from pre-brewed beverages (e.g., coffee) and brewers to subscribing members; 2) Advertising sales from subscribing members; 3) Referral fees from third party business partners; and 4) Pay Per Click (PPC) advertising fees from third party business partners.

In one embodiment, the coffee brewer advertising and marketing system disclosed herein provides a significant opportunity for online Business Services aka Software as a Service (SaaS). SaaS (Software as a Service) is a software delivery model in which business software and its associated data are hosted centrally in the “Internet cloud”. Prior to SaaS, “traditional” business software was installed on a user's computer. All maintenance of the software and data was the responsibility of the user (e.g., backup, upgrades, virus scans, etc). Prior to SaaS, the user was required to purchase the software, the servers, desktop computers, backup storage, backup power, etc. Traditional business application software often requires a large capital investment by the user.

With SaaS, the software provider (not the user) assumes all responsibility for the business software and associated data and charges the user an ongoing “rental” fee. With SaaS, the user only needs an Internet ready device (e.g., laptop, iPad, iPhone, Blackberry, etc) with a web browser (e.g., Internet Explorer, Chrome, Mozilla, etc) to operate the business software.

The benefits to the user include no capital investment in software, no capital investment in computer servers and desktops, no capital investment in backup storage and/or no need for IT staff to install, maintain and support software.

Benefits to the referring party (e.g., the member that signs up to use the coffee brewer advertising and marketing system) include recurring effortless revenue.

SaaS has become a common delivery model for most business applications, including Workforce Management (i.e. www.kronos.com); Accounting (i.e. www.QuickBooksOnline.com); Collaboration (i.e. www.collaboratecloud.com); Customer Relationship Management (i.e. www.salesforce.com); Enterprise Resource Planning (i.e. www.netsuite.com); Invoicing, Human resource Management (i.e. www.workday.com); Content Management (i.e. www.ingeniux.com); and Service desk Management. (i.e. www.autotask.com). SaaS has been incorporated into the strategy of all leading enterprise software companies.

In one embodiment, the coffee brewer advertising and marketing system disclosed herein utilizes one or more of the following steps: 1) the coffee brewer advertising and marketing system Supplier creates a member website; 2) the Supplier invites third party Online Business Service Providers (BSP) to post hyper-links on the Supplier's website (via e-mail solicitation, newspaper, etc.); 3) the BSP enrolls Supplier in BSP's referral partner program (Referral program details all terms and conditions, including referral-fee payment schedule); 4) BSP will create a special log-in page on BSP's website, exclusively for enrolled members (members will be prompted for their member ID number. Entering their member ID number entitles the member to a discount on BSP's services, while also registering the visit as a referral); 5) Supplier receives notification from BSP of a member site visit; 6) If the member subscribes to BSP service, the Supplier receives notification from BSP; and 7) BSP pays the Supplier a referral fee based on terms and conditions of BSP's referral partner program.

In one embodiment, the coffee brewer advertising and marketing system may be used for Pay Per Click (PPC) Advertising revenue from third party Online Business Service Providers. Today, advertisers may spend between $50-$500,000 per month on PPC advertising. Pay per click is paid by advertisers, each time a website visitor “clicks” on the advertiser's banner ad. A successful conversion occurs when that same website visitor purchases the advertiser's product after clicking on the advertiser's banner ad. See www.hochmanconsultants.com.

PPC is effective. The three largest PPC operators on the Internet are Google AdWords, Yahoo! Search Marketing, and Microsoft adCenter.

In one embodiment, suppliers of the coffee brewer advertising and marketing system disclosed herein will use PPC to sell online third party business services. In one embodiment, the coffee brewer advertising and marketing system operates as follows: 1) the Supplier creates a member website; 2) the Supplier invites third party Online Business Service Providers (BSP) to post hyper-links on Supplier's website (via e-mail solicitation, newspaper, etc.); 3) BSP enrolls Supplier in BSP's Pay Per Click (PPC) program (PPC program details all terms and conditions, including PPC payment schedule); and 4) BSP pays AMBeR Supplier according to PPC payment schedule.

Benefits of PPC Advertising Fees Opportunities include deriving PPC fees from participating third party online Business Service Providers, Workforce Management, Accounting, Collaboration, Customer Relationship Management, Enterprise Resource Planning, Human Resource Management, Content Management, and Service Desk Management.

In one embodiment, the coffee brewer advertising and marketing system disclosed herein enables suppliers to derive revenue from referring members to third party online Business Service Providers. The coffee brewer advertising and marketing system disclosed herein facilitates the sale of these online business services which are estimated to grow to $21.3B by 2015.

In one embodiment, the coffee brewer advertising and marketing system disclosed herein enables investors and advertisers will pay for a captive, measureable and repeat audience. The most common way for web sites to generate revenue is to allow companies to advertise on the site. The more popular the web site, the more money it will be able to generate through advertising. For example, a social networking site (i.e. Facebook) has millions of active repeat visitors. Access to that enormous captive, measurable audience is a multi-billion dollar asset.

A popular website is one that draws repeat users. Content which users perceive as valuable, easily accessible, searchable and frequently needed will draw repeat visitors. The coffee brewer advertising and marketing system disclosed herein uses the Internet to sell content (coffee), which enables members to generate revenue by delivering two highly demanded sources of content. The system attracts a captive, measurable and repeat audience. Investors and advertisers will pay for a captive, measurable and repeat audience.

Internet retailers who are successful marketing to individual consumers have limited access to business consumers. Internet retailers often have difficulty target-marketing to businesses since often mostly only individual consumers shop online, providing only their personal information. Therefore Internet retailers have difficulty obtaining business consumers' demographic profiles.

Internet retailers who are successful marketing to individual consumers have limited access to business consumers. The coffee brewer advertising and marketing system disclosed herein preferably encourages business consumers to submit their demographic profiles online by offering business consumers: free B2B advertising (i.e. banner ads); free/subsidized pre-brewed beverage and deliveries; and potential advertising revenue.

The coffee brewer advertising and marketing system is an improvement over what currently exists. Internet retailers who are successful marketing to individual consumers have limited access to business consumers. Internet retailers currently have few compelling reasons for business consumers to provide their respective demographic profiles. Thus Internet retailers remain challenged how to target market business consumers.

Internet retailers successful marketing to individual consumers have limited access to business consumers' employees. Internet retailers are challenged by reaching business consumers' employees because the business consumer's network usually has firewalls and security measures blocking Internet content from reaching employees' computers.

Using the coffee brewer advertising and marketing system disclosed herein, the beverage brewers can communicate directly with the Internet via a wireless network (i.e. Wi-Fi or GPRS) or wired-network connection. Since the brewers work only with pre-programmed cups, the Internet retailer can be assured the consumer will continue re-ordering only pre-brewed beverages supplied by the Internet brewer retailer, which guarantees recurring residual pre-brewed beverage-revenue after the sale of the brewer.

In one embodiment, the supplier's brewers and pre-brewed beverages are pre-programmed at the factory with “vendor acceptance codes”. The supplier's brewers will not operate unless the code of the beverage matches the vendor code pre-programmed on the brewer.

Additionally, upon the Internet retailer's request, the supplier's brewers can also be remotely re-programmed after the sale to switch their beverage vendor acceptance code. Thus, the Internet retailers can easily switch pre-brewed beverage vendors easily and quickly after the sale. For instance, a brewer sold with a “Starbucks vendor code” can later be changed to operate only with “Green Mountain coffee.”

Internet retailers have no recurring residual revenue after the sale of appliances (e.g., a brewer). Some brewer manufacturers are already producing brewers which only work with their respective pre-brewed beverages (i.e. Green Mountain Coffee and Keurig). But this ties the retailer to only one pre-brewed beverage vendor. The coffee brewer advertising and marketing system disclosed herein is unique because it allows retailers to change the pre-brewed beverage vendor any time the retailer desires (e.g., after the sale).

Few business models generate recurring revenue (e.g., utility companies, lease/rental contracts, finance charges etc.). But even if a business generates recurring revenue and repeat customer business, real growth is determined by how many new customers can be attracted. And there is always a cost of sales when obtaining new customers.

The coffee brewer advertising and marketing system disclosed herein helps create new recurring revenue outside a business' core competency and is not limited by how many new customers can be attracted. In fact advertising companies will sell the ad space on the beverage brewer for a member. There are many “placed based media companies to help (e.g., Ready Media Group—www.rmgnetworks.com).

Pre-brewed beverage brewers have no security. Anyone who has access to the brewer and pre-brewed beverages can make a free cup of pre-brewed beverage. Many expenses are incurred by business owners who provide brewed beverages to employees including cost of brewer; cost of pre-brewed beverages; cost of electricity; and cost of condiments. Today's beverage brewers can be easily accessed by both welcome and unwelcome parties.

In one embodiment, the coffee brewer advertising and marketing system enables the beverage brewers to only be operated by authorized users. The coffee brewer advertising and marketing system has brewers that recognize users by various identification methods including fingerprint ID, face ID, Prox/RFID card ID, and PIN code ID. Only when the brewer recognizes an authorized user will it operate, which prevents unauthorized parties getting free beverages.

Although some brewers have built-in fingerprint readers, the fingerprints are not used to prevent unauthorized use of the brewer. Brewers on the market having fingerprint recognition technology are merely used to record and dispense beverages based on the recorded user's preference (i.e. espresso/cappuccino, strong/mild, light/black, sweet, etc.).

Internet marketing companies cannot reach non-computer users. Internet marketing companies cannot reach potential consumers unless the consumer has Internet access (e.g., access to desktop and/or portable computers). Not all consumers outside their homes or offices have continual access to the Internet. Concerned for productivity loss, many companies have policies restricting employees from using their phones while at work.

The coffee brewer advertising and marketing system has brewers with Wi-Fi connectivity, which can display interactive advertisements downloaded (or streamed) from the Internet. The brewers will be installed and displayed in centrally located areas within offices/stores in which potential consumers are confined to sitting (or standing) still and will be inclined to view its running advertisements. The ads will be viewed by captive audiences whose demographics can be measured.

Currently, Internet marketing companies can only reach consumers with access to the Internet via desktop (if firewalls permit) and portable computers and smart phones. The brewers disclosed herein allow Internet marketing companies to display ads to consumers who have no access to the Internet while at work or while visiting other businesses displaying ads (e.g., patient waiting room, nail salon waiting room, laundry mat, car wash, etc).

Traditional broadcast advertising mediums (e.g., TV, radio, newspapers) are the most effective way for advertisers to reach as many possible consumers as possible. As a consequence, broadcast advertising is also the most expensive advertising medium. An extreme example is the 2009 Super Bowl in which a major television network charged advertisers $3M for running 30-second advertisements.

The coffee brewer advertising and marketing system disclosed herein lessens the cost to advertisers in at least two ways: 1) the brewer has an interactive touch-screen which displays ads. Viewers interested in the ads being displayed can touch the interactive screen and print coupons or request more information from the advertiser. In this manner, the advertiser knows exactly how many viewers have actually seen the advertisement. This closely models the very successful “per-Click” Internet advertising strategy which is extremely cost-effective and seldom requires an upfront advertising cost. Advertisers merely pay for each “click”. 2) The brewers will normally be installed in businesses which have kitchens or waiting rooms (e.g., doctor's office). The consumers in these waiting rooms for all intents and purposes are a “captive audience” because they need to sit and wait before they are serviced. Thus, the business owner knows exactly how many consumers they service each day. Therefore, advertisers only need pay for the number of consumers who will be in the waiting room each day who view the prospective advertisers' ad.

Advertisers wishing to lessen the cost of advertising can use Online advertising strategies including pop-ads and banner ads. But viewing Internet ads requires the consumer be logged on to a computer and actively conducts searches and visits websites. The consumer's actions determine whether or not the ad will be displayed. The placed ad's appearance is reactive to the user's actions. However, with the coffee brewer advertising and marketing system disclosed herein, an advertiser is in full control of displaying the ad and is more so assured their respective ad(s) will be seen by the consumer.

The consumer and the brewer are usually both situated in an office kitchen or small waiting areas (e.g., dentist's waiting room, retail store checkout stand, laundry mat, etc.) where the consumer has few viewing distractions.

The coffee brewer advertising and marketing system disclosed herein will have comparable costs of running pop-up and banners ads, but will have far greater ad-viewing results.

Difficulty for Advertisers wishing to target-market. In addition to cost, a major downside of broadcast advertising is its inability to reach the advertiser's target market. During the 2012 Super Bowl, advertisers pitched their respective products and services to football fans (and their friends and family members). These advertisers spent millions of dollars advertising to viewers who like football, but do not necessarily fit the advertiser's preferred target-market or consumer profile.

Broadcast advertisers attempt narrowing down and better targeting their preferred consumer market by carefully selecting the type of TV show and time slot in which the advertiser will advertise their product or service. For instance, a toy manufacturer will generally advertise at times when children are watching cartoons. However, broadcast television advertising is very expensive and it is still difficult to determine the demographic makeup of the children viewing the programs, or more importantly, their parents who actually make the toy purchase decision.

In one embodiment, the coffee brewer advertising and marketing system disclosed herein will be installed in businesses which have kitchens or waiting rooms (e.g., doctors' offices, dentists' offices, car washes, beauty salons, accounting offices, car service stations, laundry mats, etc.). These businesses have potential consumers in their respective waiting rooms with very specific needs. For example, a pharmaceutical company can target-market their new acne medication by displaying their ad on the beverage brewers installed in a dermatologist's office. A car wash owner can target-market their services by displaying their ad on beverage brewers installed in auto-repair shops while customers await the return of their repaired car.

Advertisers often attempt target marketing of either a geography or demographic. If targeting a specific geography, the advertiser can list their ad in the local Yellow Pages/phone book for that geography. If targeting a specific demographic, the advertiser can list an ad in a specialty magazine. The coffee brewer advertising and marketing system disclosed herein enables advertisers to uniquely target both geography and demographics at the same time. For example, a drug company selling cholesterol reducing medication can use the system to target market all cardiac patients residing within a 10-mile radius of a specified zip code. A pizzeria can use the system to target market only businesses' employees within a 10 city-block radius for a lunch special. On the contrary, advertising pizza lunch specials to consumers 20+ blocks away would most likely be a wasted advertising expense since most city workers won't walk 20+ blocks to save $1 on a slice of pizza.

Another problem with broadcast advertising is it is extremely difficult to determine the precise “viewership” of any particular advertisement. Nielsen Ratings provide a good measurement of viewers watching a particular TV show during a specific time slot. But advertisers have no way of knowing how many viewers actually see their respective advertisements, even though the viewer is tuned into the TV show. Viewers often skip commercials when viewing previously recorded programs on DVD players.

It is also very possible the viewer changed channels or walked away from the TV during the paid commercials. And regardless how large a newspaper's circulation, the publisher has no way of reporting to advertisers how many readers actually read each respective printed advertisement.

The coffee brewer advertising and marketing system disclosed herein has brewers that will normally be installed in businesses which have kitchens or waiting rooms (e.g., doctor's office). As a result, the business owner knows exactly how many people they employ and how many consumers (i.e. patients) visit each day. By communicating this information to prospective advertisers, the advertisers can calculate more accurately the rates of return for each respective advertisement.

Additionally, consumers viewing advertisements on the beverage brewers disclosed herein have an opportunity to interact with the brewers' touch-screen display and request more information from the respective advertisers. These consumer interactions may be logged and can be reported back to the respective advertisers as measurable proof of how many consumers actually viewed the advertisers' respective advertisements.

The coffee brewer advertising and marketing system disclosed herein provides advertisers statistics on the number of consumers actually viewing their respective ads (or most likely viewed the ad while being in close proximity of a brewer). Consumers watching TV or reading a newspaper are inundated with advertisements. If an advertiser is listed in a newspaper or aired on television, the advertiser is competing for the consumer's attention. It becomes very easy for a consumer to get “lost” in a sea of advertisements. However, the brewers disclosed herein primarily display targeted ads designed specifically for the respective advertiser's viewing audience.

As opposed to traditional broadcast advertising, with the system disclosed herein, it is much more likely that a consumer will view ads run on one of the system's brewers, remember the ad, and act upon the ad by purchasing the respective advertisers' products and/or services.

Business owners are desperate to retain customers. Business owners cannot service all their customers at the same time. Customers often have no choice but to sit patiently in the business owners' waiting rooms until they can be serviced.

To discourage impatient and quite possibly bored customers from leaving, business owners often try to appease customers in the waiting room by offering free coffee, reading material, playing music or perhaps operating a television. While these offerings may help, customers still have limited patience and receive no real benefit being entertained.

The selection of reading material or television programming is at the discretion of the business owner. It is quite possible that some of the patients/consumers may not even like the reading material or TV station being played.

While business owners attempt to keep impatient waiting-customers entertained with magazines, TV or radio, these trivial things offer no real value to the customer. However, the brewers disclosed herein can display relevant information to the customer and generate coupons from advertisers who specifically cater to the needs of the customers in the waiting room (or employees in the office kitchen). The coffee brewer advertising and marketing system disclosed herein is a true value-add for business owner's wishing to keep their customers happy by offering valuable services (ex. product/service education, discounts, points/rewards programs, etc.).

The coffee brewer advertising and marketing system disclosed herein provides customers worthwhile relevant information on products/services which most likely will interest the customer. The brewers can also provide customers/patients coupons helping the customer save money when purchasing products advertised on the brewers.

Internet retailers are challenged by how to differentiate their pre-brewed beverage brewer. Premium brewer manufactures spend tremendous R&D dollars perfecting the most convenient best tasting pre-brewed beverage and then charge retailers and consumers a premium, accordingly. But retailers selling low to medium quality brewers have tremendous challenges differentiating and marketing brewers perceived by the public as “commodities.” Typically retailers sacrifice profit margin to sell the brewers lacking distinctive selling advantages.

The coffee brewer advertising and marketing system disclosed herein has brewers that brew brand name quality beverages. In one embodiment, the coffee brewer advertising and marketing system cost the buyer nothing to acquire and operate. The coffee brewer advertising and marketing system disclosed herein has the ability to recognize the pre-brewed beverage consumer (typically an office employee) and deduct from the respective consumer's pay check the price for a cup of pre-brewed beverage, and perhaps a % of the cost of the brewer, itself.

The owner of the coffee brewer advertising and marketing system disclosed herein determines how much (if any) to charge the pre-brewed beverage consumers. Hence the cost of the system is paid by its consumers.

Internet retailers are challenged by how to differentiate their pre-brewed beverage brewer. Currently, brewer manufacturers are unable to offer free pre-brewed beverages and brewers because there is no way to automatically deduct charges from consumer's paycheck.

Competing “non-premium” brewer manufacturers remain challenged differentiating their respective brewers from “non-premium” competitors.

Advertisers paying for placed based media (e.g., gas pumps, passenger elevators, vending machines, urinals) are limited to small screen displays. Based on limited space, advertisers' content may be difficult to view.

Although the system's brewers' display screens may be less than 10 inches in diameter, the brewers disclosed herein may wirelessly display advertising content on larger screen displays (tabletop and wall mounted).

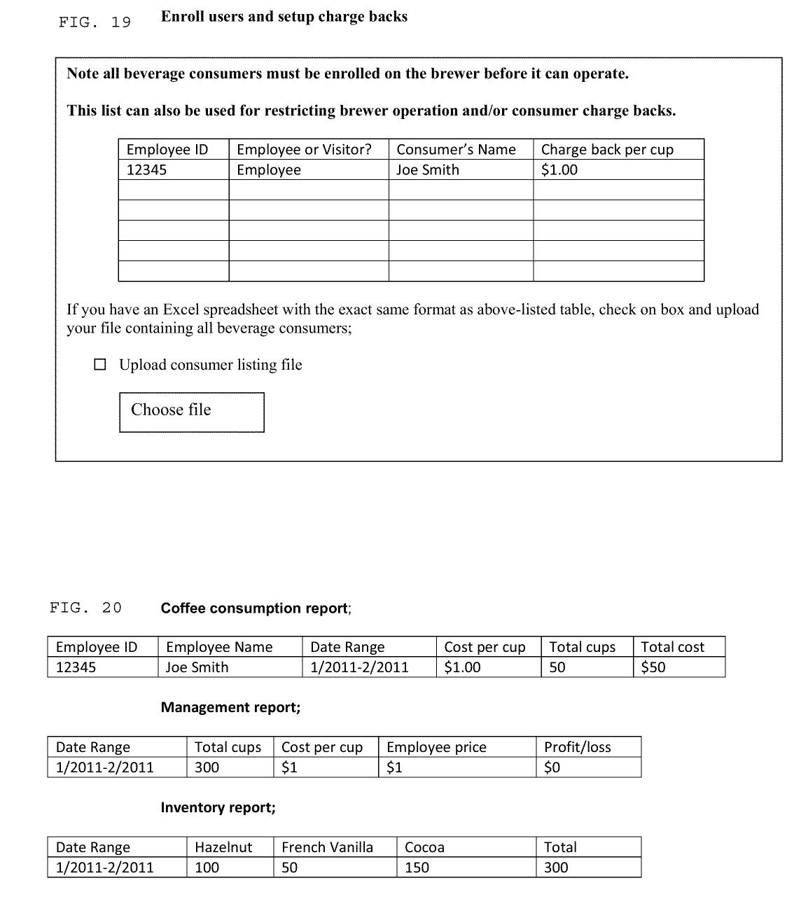

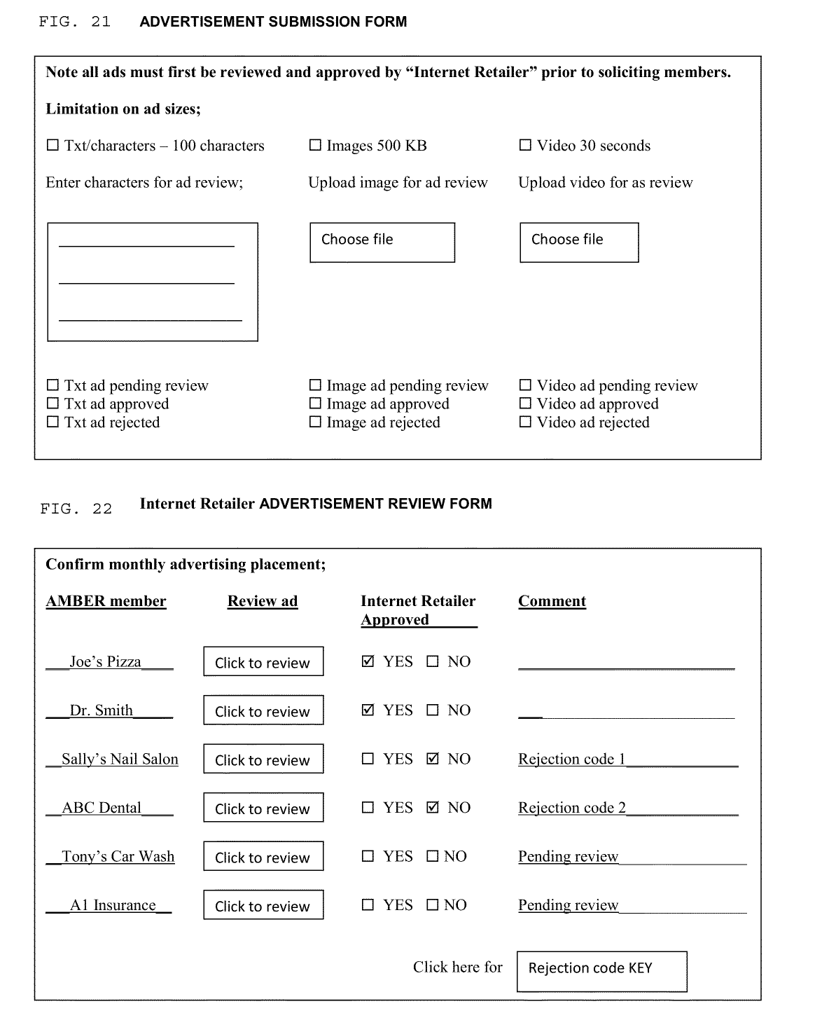

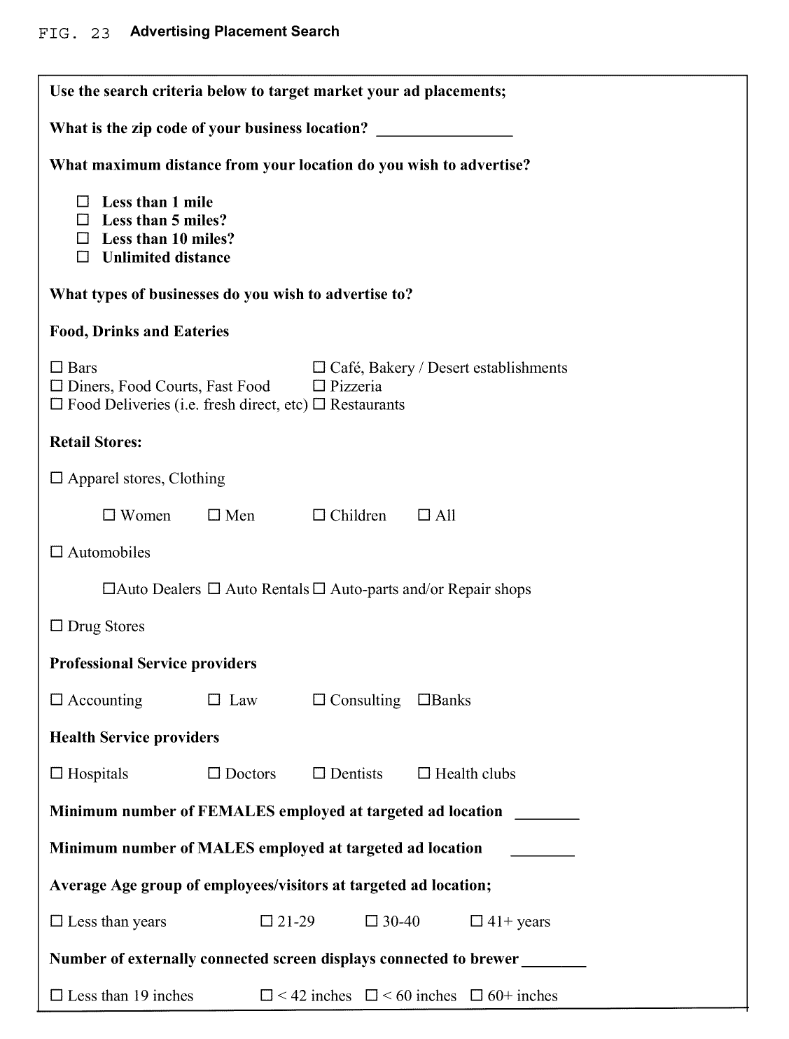

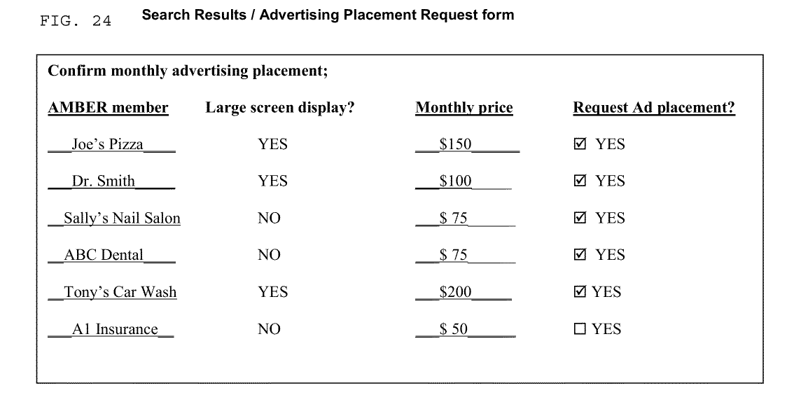

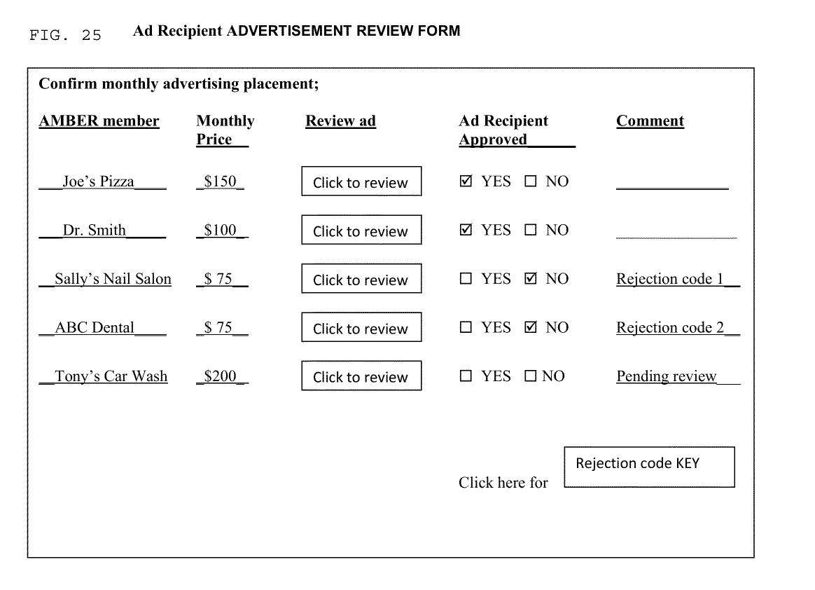

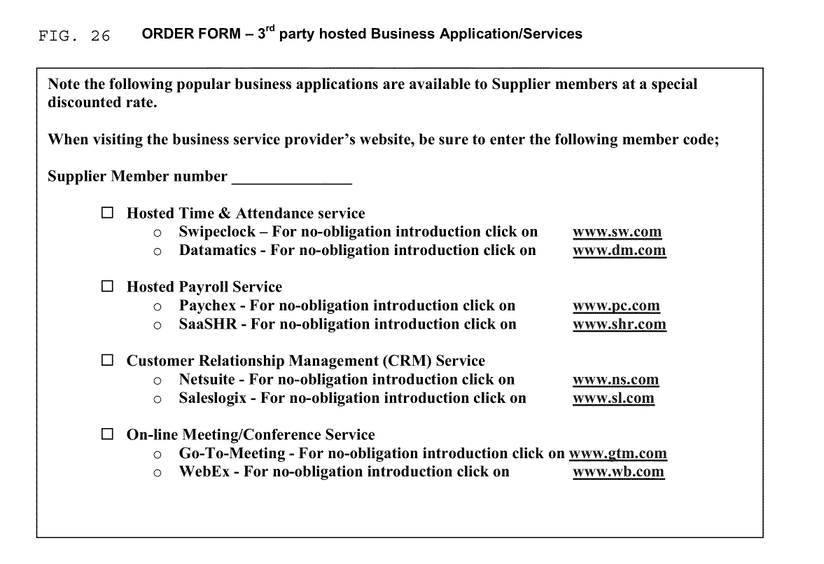

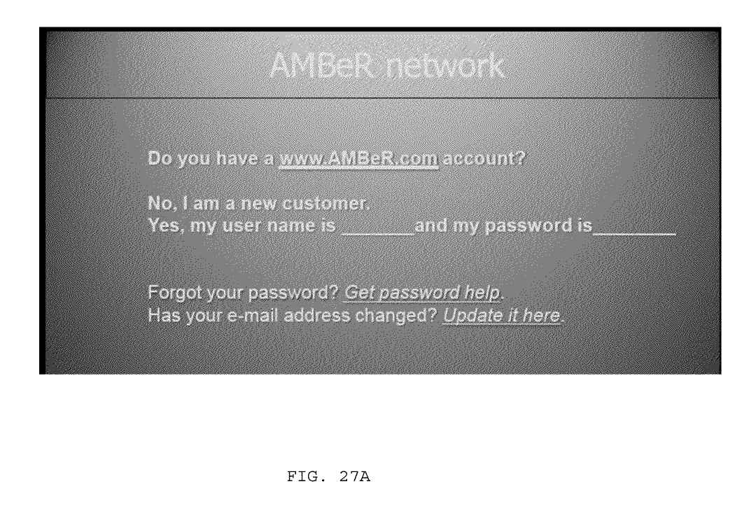

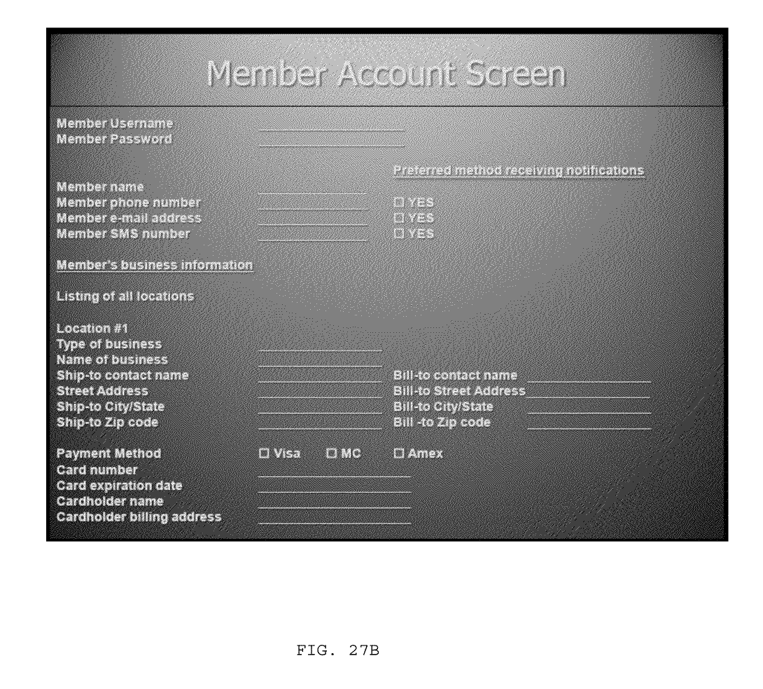

The coffee brewer advertising and marketing system disclosed herein may include a website for operating the system. FIG. 13 shows a sign-in screen. FIG. 14 shows an account information screen. FIG. 15 shows an advertisement review/approval form. FIG. 16 shows a main selection screen. FIG. 17 shows a member business profile screen. FIG. 18 shows an order form for ordering coffee and condiments. FIG. 19 shows an enroll users and setup charge backs form. FIG. 20 shows a coffee consumption report, a management report, and an inventory report. FIG. 21 shows an advertisement submission report. FIG. 22 shows an internet retailer advertisement review form. FIG. 23 shows an advertisement placement search.

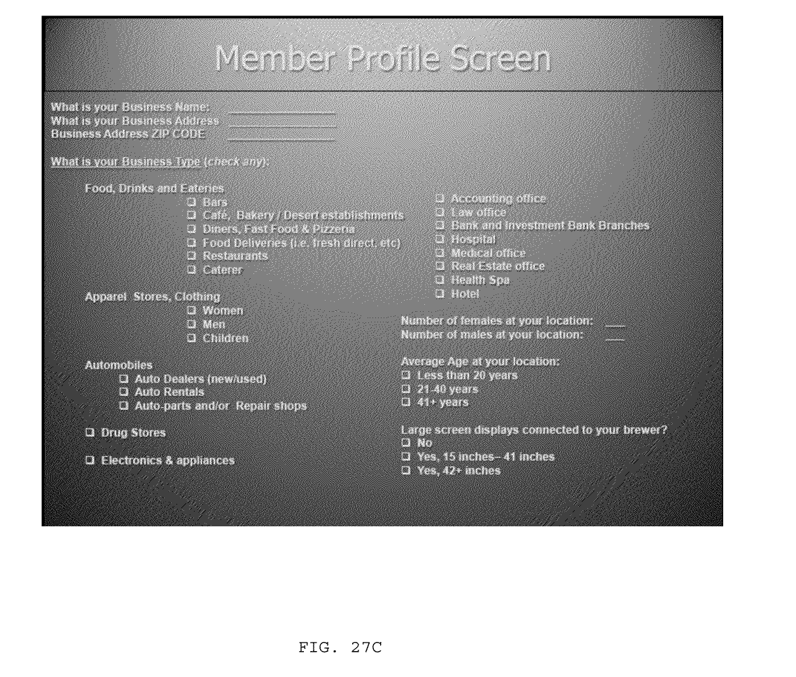

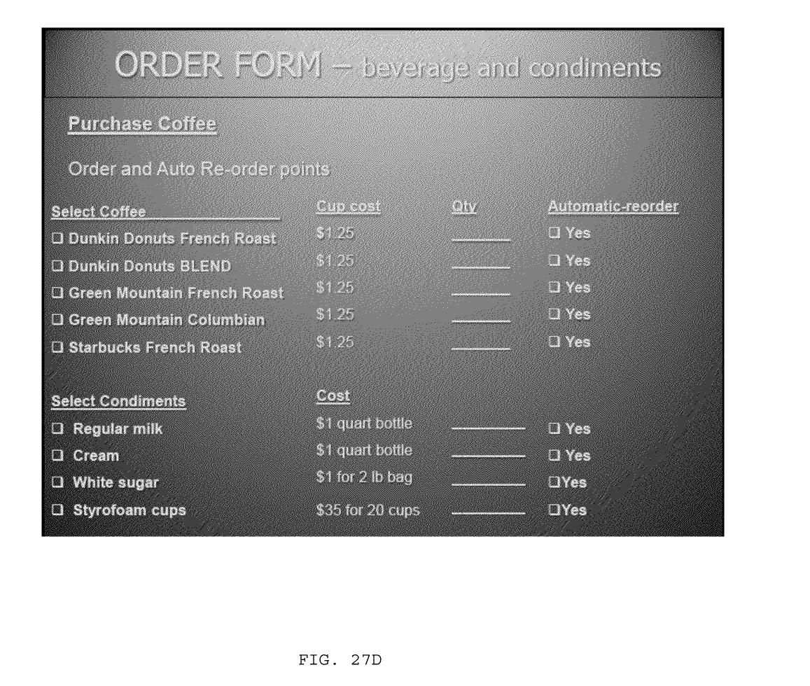

FIG. 24 shows a search results/advertising placement request form. FIG. 25 shows an ad recipient advertisement review form. FIG. 26 shows an order form for third party hosted business application

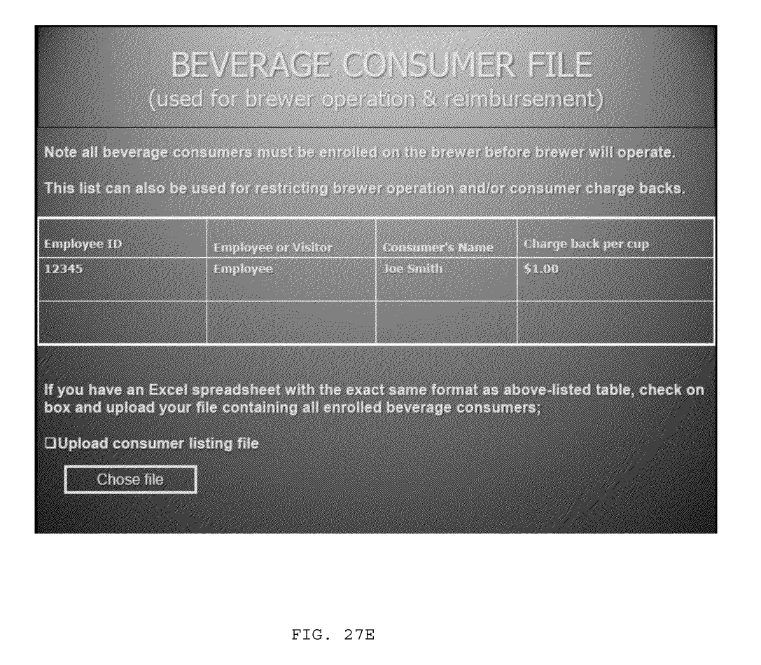

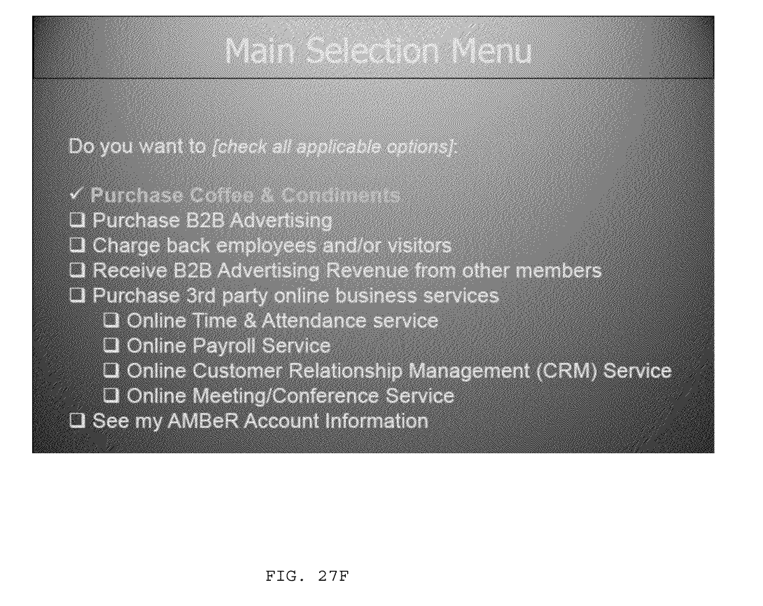

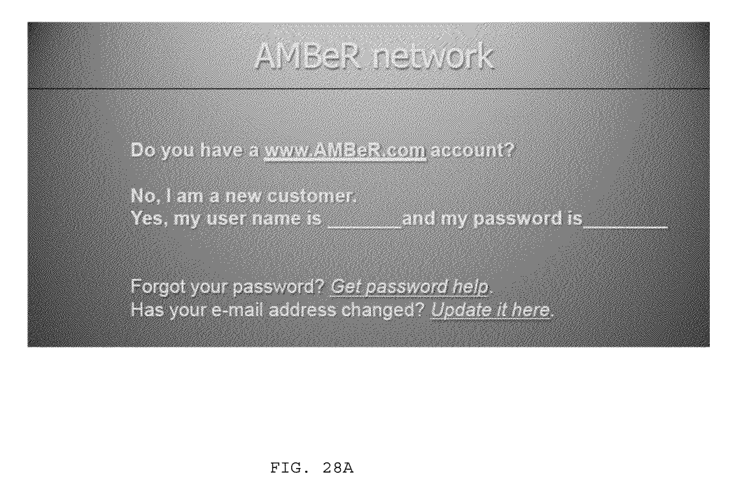

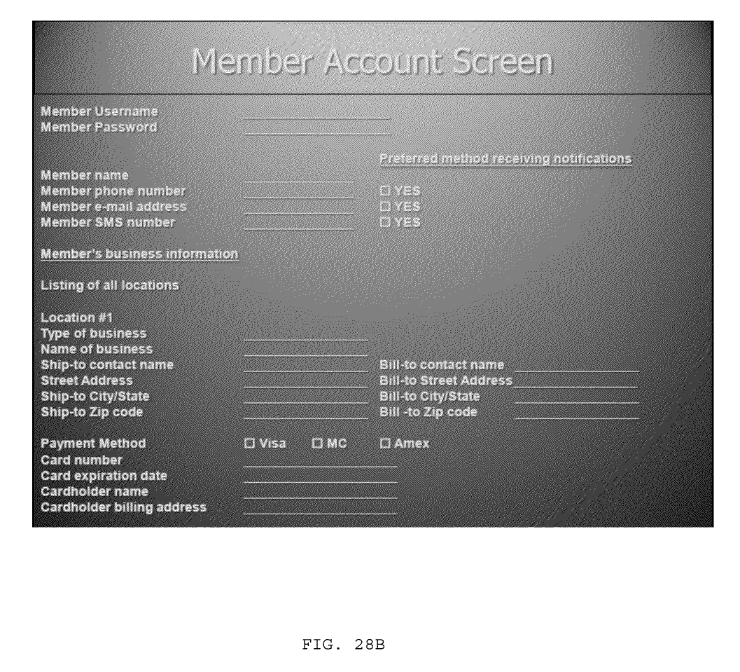

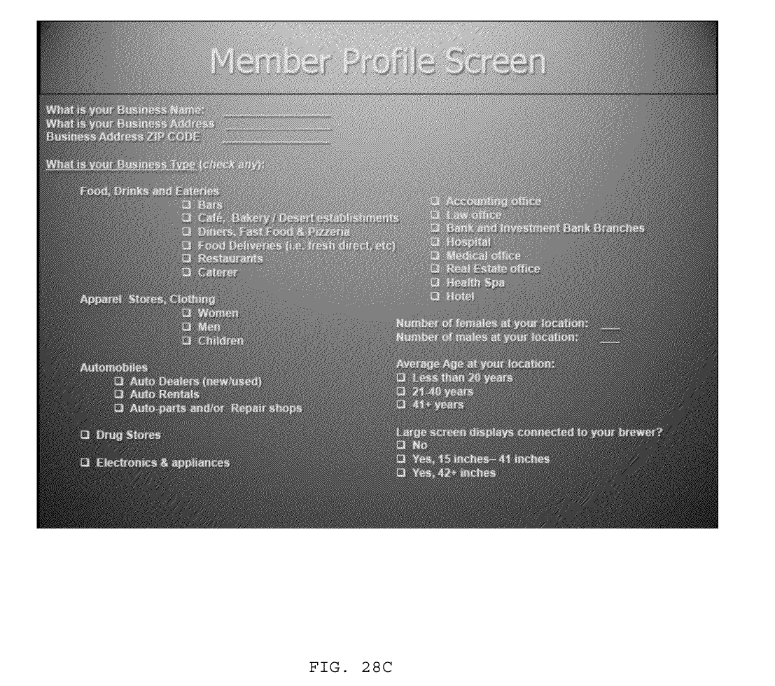

FIGS. 27A-27F show website pages for a beverage sales subroutine for the coffee brewer advertising and marketing system disclosed herein.

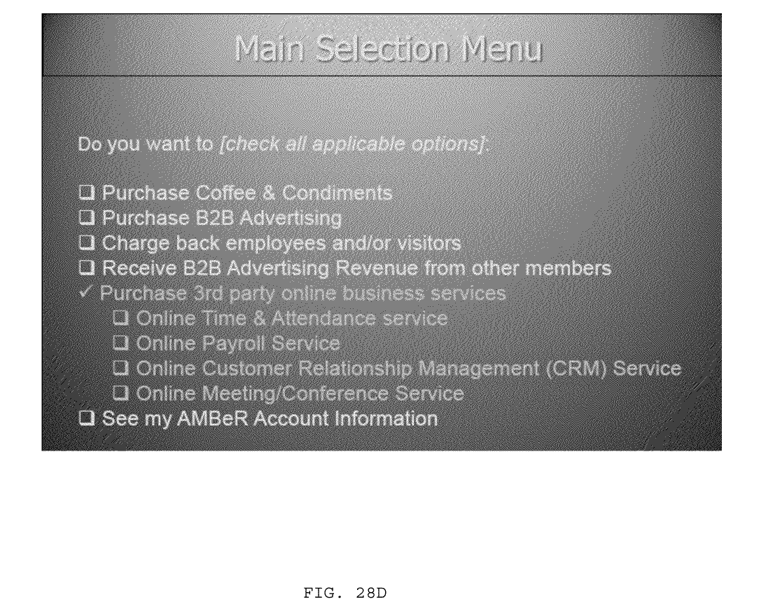

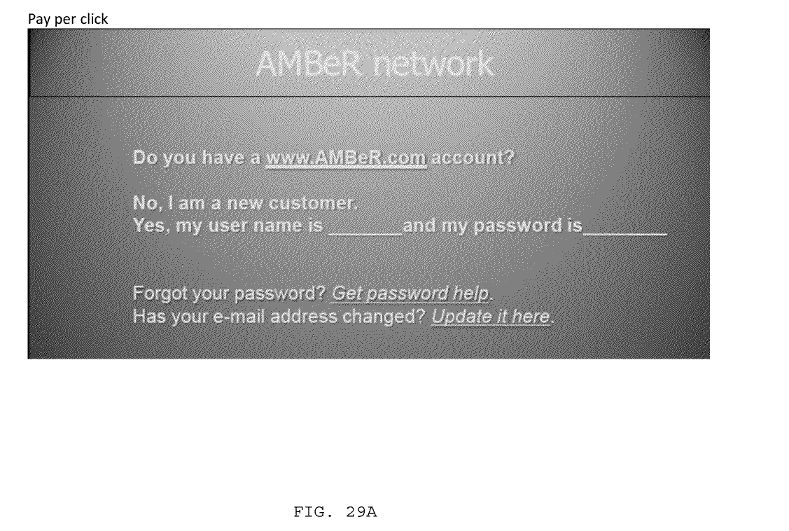

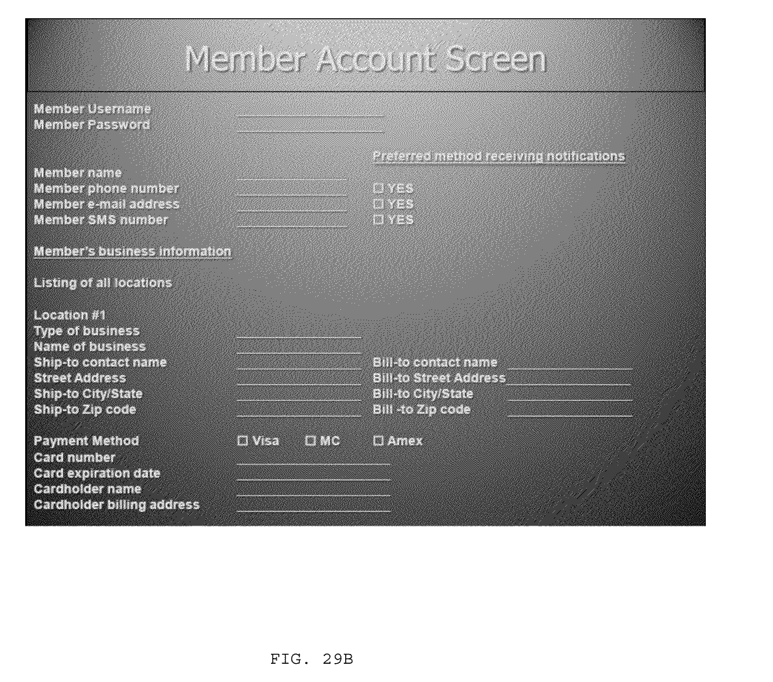

FIGS. 28A-28D show website pages for an on-line business referral subroutine for the coffee brewer advertising and marketing system disclosed herein.

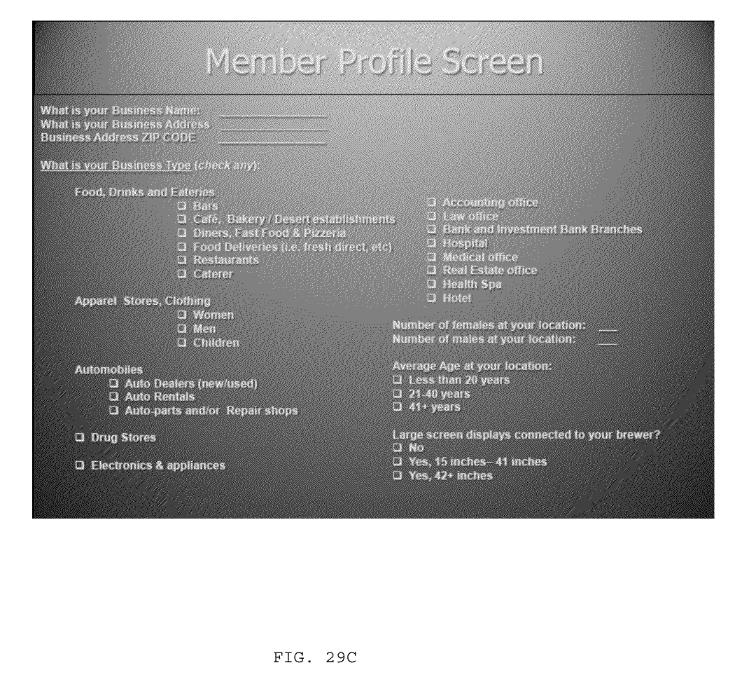

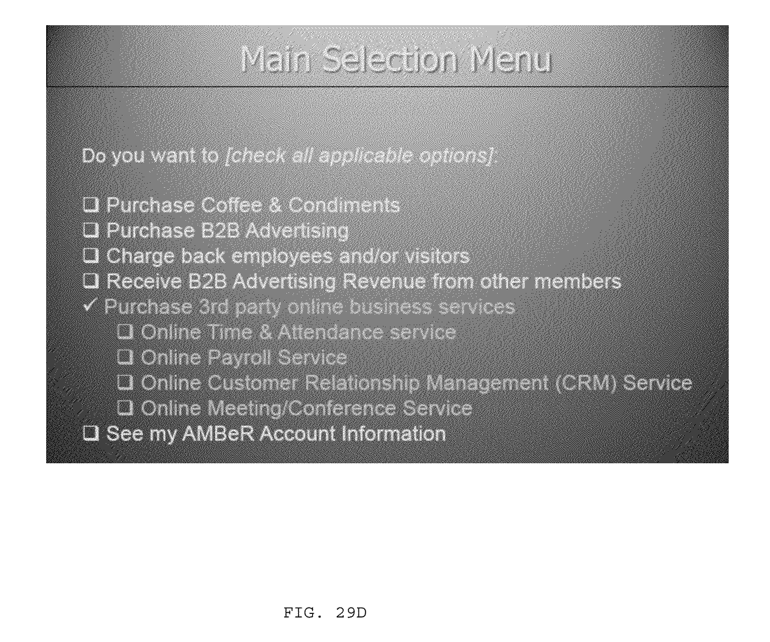

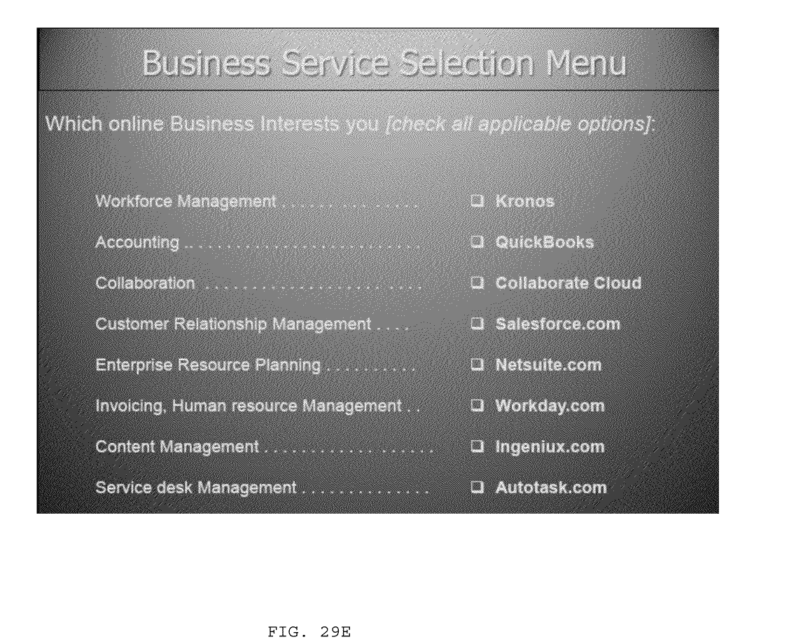

FIGS. 29A-28E show website pages for a pay per click subroutine for the coffee brewer advertising and marketing system disclosed herein.

In one embodiment, a retailer creates membership website and invites members to enroll

The page welcomes the visitor, provides a brief introduction of the Internet retailer's company, and then invites the visitor to enroll in the system. The benefits of enrolling include 1) Free (subsidized) brewer and pre-brewed beverage (e.g., coffee, tea, cocoa, etc), and 2) ability to track and control employees' beverage consumption and charge the employees for beverage consumption, accordingly.

In one embodiment, the only enrollment requirement is visitors must provide basic demographic data describing their office location (e.g., name of business, office location address, company website, products/services sold at the location, number of males working at location, number of females working at location, main contact's name, main contact's title, main contact's phone number and main contact's e-mail address). Visitors must also indicate how many brewers they operate in their office and if large screen displays will be attached to the brewer. Informing prospective advertisers that large screen displays will be used by the member will potentially attract higher advertising fees for the respective member

In the step of informing, the Internet Retailer invites business owners to visit the website and subscribe to the system and program. The invitation may take the form of e-mail, newspaper, radio, business publications, introduced at tradeshows, etc. The invitation welcomes the prospective new members by introducing the prospective member to the Internet Retailer's company and then invites the prospective member to enroll in the Internet Retailer's “coffee club program.”

Member enrolls and provides Retailer their new Member's business profile. Providing the member profile information is important because members interested in advertising their respective products and services can target market by using specific demographic information provided by other members. This is the same approach used by social networking and dating websites when members conduct searches.

When enrolling, new members will be prompted to provide the following demographic data which describes each of the member's office locations.

Informing prospective advertisers that a member has large screen displays can be an incentive to attract more advertising revenue.

Newly enrolled member informs Internet Retailer by ordering brewer and beverages. The newly enrolled member then decides which vendor's pre-brewed beverage, condiments, related consumables and quantities to order. When the member's inventory runs low (or out) the member can then revisit the website and either manually order replenishment pre-brewed beverages or they can select automatic delivery for when member's pre-defined re-order points are met.

This initial inventory of pre-brewed beverages is recorded in the member's account profile (e.g., six packages hazelnut coffee, 10 packages cocoa, etc.) which can later be used to track beverage usage patterns and help establish beverage re-order points. Once re-order points are reached, a notification can be communicated to the member, or pre-brewed beverage replenishment can automatically be re-ordered.

Retailer ships brewer, beverage and related consumables. The Retailer ships vendor-specified brewer, pre-brewed beverage, condiments and related consumables to member.

Member receives and installs brewer. The brewer is installed in the member's business establishment. The brewer plugs into any normal power outlet as do similar appliances. However, the brewer also has communication ports (i.e. TCP/IP, Wi-Fi, GPRS, etc) to used to connect with the member's network, the Internet, and the Retailer's website.

Member enrolls users on (e.g., employees and repeat visitors) on the Internet Retailer's website via any networked computer. Information provided includes the users ID#, whether the user is an employee or repeat visitor, user's name, and how much (if any) user will be charged back for a cup of beverage. These charges will appear in reports available online, so members can deduct from the respective employee's paycheck, accordingly.

The member will “enroll” users on the brewer with an “identifier” which uniquely identifies the user when the user interacts with the brewer. Note the brewer will only dispense beverages to users enrolled on the brewer. An identifier can take the form of a fingerprint or face scan (biometric), RFID or barcode/magnetic stripe scan, or a PIN code. Any means of acquiring a user's information and identifier and subsequently storing both/either on the brewer and communicating it to the Retailer and participating members is within the scope of the present invention/methodology.

Member's user(s) places a pre-brewed beverage cup/pod into brewer's holding cup. The member's user(s) will place a single-serve cup/pod of pre-brewed beverage into the brewer's holding cup (as with any single-serve beverage brewer). The brewer then records information provided by the cup/pod (via a printed bar code label on the top of the cup or embedded RFID chip in the cup's outer membrane). The brewer only dispenses beverage if the brewer recognizes the cup/pod's beverage-vendor code.

Note the brewer is pre-programmed (prior to shipping) with a beverage vendor code. The brewer is programmed to operate only when the brewer recognizes single serve beverage cups/pods programmed with the very same matching vendor code programmed by the internet Retailer. This is accomplished by either printing a bar code label on the top of the beverage cup or by embedding an RFID chip inside the outer membrane of a single-serve cup. The brewer has a corresponding bar code and/or RFID reader. Only if the brewer's reader (bar code and/or RFID) correctly identifies the single-serve beverage cup/pod with SAME matching vendor code, will the brewer operate and brew/dispense the pre-brewed beverage.

If no match occurs, the brewer will not dispense the pre-brewed beverage. The brewer can be programmed to flash a warning message on its touch-screen display noting the pre-brewed beverage cup/pod is not approved to be used with the brewer. If a match occurs, the brewer then awaits for the user to authenticate/prove his/her identity as an authorized beverage user.

The enrolled user will then authenticate to the brewer by presenting his/her credential which was previously enrolled on the brewer during initial installation/set-up. For instance, users can authenticate to the brewer by either placing his/her fingerprint on the brewer's fingerprint sensor, placing his/her face in view of the brewer's camera, swiping his/her ID card within proximity of the brewers' ID card reader or by entering his/her PIN code on the brewer's keypad (or touch-screen).

If no match, the user needs to be enrolled. If yes match, the brewer dispenses the pre-brewed beverage, the brewer records consumer's usage, the brewer prints receipt (optional). In one embodiment, the brewer only dispenses the pre-brewed beverages if the two criteria are both met, namely, the pre-brewed beverage “vendor code” matches the brewer's “vendor code” and the brewer correctly identifies the user's credentials (e.g., fingerprint, face, card or PIN).

The brewer communicates the beverage consumption for inventory purposes and subsequent reorder. The brewer checks if the member's reorder-point has been reached. If no, the brewer takes no further action and the methodology is completed. If yes, the member' profile re-order preference is executed, either the beverage is automatically reordered which completes methodology or the retailer sends notification (SMS, e-mail, etc) to member, informing member that beverage re-order point has been made.

Methodology for generating revenue from advertising. For the Internet Retailer, the Methodology encourages membership enrollment in the Internet Retailer's advertising program. Internet Retailers will derive revenue from selling ad space to Advertising Members.

For the member/customer, the Methodology provides a means to derive revenue from selling ad space to Advertising Members.

Internet Retailer creates membership website and invites members to enroll. In the step of Informing, the Internet Retailer creates a website/page (i.e. www.coffeeclub.com). The page welcomes the visitor, provides a brief introduction of the Internet retailer's company, and then invites the visitor to enroll in the Internet Retailer “coffee club program.”

The benefits of enrolling are brief but compelling; 1) a free ad placement on participating members' brewers, 2) ability to derive ad revenue from participating members who wish to place their respective ads on the newly enrolled member's brewer.

The only enrollment requirement is visitors must provide basic demographic data describing their office location (i.e. Name of business, Office location address, Company website, Products/Services sold at the location, Number of males working at location, Number of females working at location, Main contact's name, Main contact's title, Main contact's phone number and Main contact's e-mail address). Visitors must also indicate how many brewers they operate in their office and if large screen displays will be attached to the brewer. Informing prospective advertisers large screen displays will be used will potentially attract higher advertising fees.

Internet Retailer invites members to enroll (via e-mail, newspaper, etc.) In the step of Informing, the Internet Retailer invites business owners to visit the website and subscribe to the “coffee club program.” The invitation can take the form of e-mail, newspaper, radio, business publications, introduced at tradeshows, etc.

The invitation welcomes the prospective new members by introducing the prospective member to the Internet Retailer's company and then invites the prospective member to enroll in the Internet Retailer's “coffee club program.”

Why join the coffee club? By joining, the members receive the following benefits: Free banner ad on others members' brewers; ability to target market the member's products/services to fellow members; ability to generate advertising revenue from Advertising Members.

Member receives Internet Retailer's invitation and decides whether to enroll. Member enrolls and provides Internet Retailer their new member's business profile. Providing the member profile information is important because members interested in advertising their respective products and services can target market by using specific demographic information provided by other members. This is the same approach used by social networking and dating websites when members conduct searches.

New members will be prompted to provide the following demographic data which describes each of their office locations; Name of enrolling member's business; Mailing address of enrolling member's business; Company website of enrolling member's business; Primary products/services sold by enrolling member's business; Number of male employees working at enrolling member's business location; Number of female employees working at enrolling member's business location; Main contact's name; Main contact's title; Main contact's phone number; and Main contact's e-mail address.

Member informs how many beverage brewers will operate. Member informs how many (if any) external screen displays will be connected to the brewers. Informing prospective advertisers that a member has large screen displays can be an incentive to attract more advertising revenue.

Newly enrolled Advertising Member provides ad content for the purpose of gaining exposure for their respective products and services and hopefully increase sales. After the ad content will be displayed on members' brewers specified by the Advertising Member.

Ad content can be created in many formats (i.e. digital banner ads with fixed character length scrolling across the brewer's display, static digital images of advertiser's product or company logo appearing on brewer's display, product coupons printed from brewer, and/or fixed length video commercials. Note there exists today media companies which can help advertisers create commercial video ad content (i.e. http://oneononeads.com).

Advertising Member submits ad content to Internet Retailer for approval and storage. Newly enrolled Advertising Member provides ad content (via the Internet) to Internet Retailer for review. The Internet Retailer will have pre-established guidelines which determine which member-submitted-ad-content is deemed acceptable and appropriate for subsequent distribution to agreeable members' (aka Ad Recipient Members) brewers. The Internet Retailer and Advertising Member will share the Internet Retailer ADVERTISEMENT REVIEW FORM for status (i.e. approved or rejected ads). A list of pre-defined “rejection codes” will be provided so that the Advertising Member understands what changes to their respective ad are necessary, prior to the Internet Retailer approving the ad.

Also note Advertising Members can advertise on Internet Retailer's. Since members will repeatedly revisit Internet Retailer's website each time they wish to re-order beverages or advertising, this presents a viewing audience for the Advertising Member(s). Advertising Member(s) can purchase ad space on website to display their respective ad content (i.e. banner ad, image/logo, video, etc).

Once Internet Retailer deems the Advertiser's as content is acceptable, the Internet Retailer stores the Advertising Member's respective ad content for pending distribution to agreeable members' (aka Ad Recipient Members) brewers.

Advertising Member decides where they will place their ad content, by conducting a search on Ad Recipient Members which meet the Advertising Member's target market demographics.

Member business profiles are stored in an online database maintained by the Internet Retailer and are accessible to the public (both members and non-members). Since it is assumed all members want the opportunity to derive advertising revenue (provided the member has the right to refuse inappropriate ads), the members' profiles are available to the public.

This approach is no different than the very successful model used by social/dating sites. It is free to search the member database of these social/dating sites. But a fee needs to be paid if non-members wish to contact members. Likewise, while non members can search the member database for targeted Ad Recipient Members, non-members first must become members and pay an advertising fee in order to advertise on the members' brewers.

System members can be searched upon by various demographic criteria (e.g., distance from specific zip code, business category, number of female employees, number of male employees, average age range, advertising rates, etc.). The ability to search on these demographic criteria helps Advertising Members better target-market their respective products and services. Advertising Members can then choose from their search results, which members the Advertising Member wishes to advertise their respective products and services.

Advertising Member submits ad content “display-request” to select Ad Recipient Member(s) which appear in the Advertising Members' search results. Ad Recipient Members match the Advertising Members' target market demographic criteria used during searching. Search results will display Ad Recipient Members' company name, whether or not Ad Recipient Member has a large-screen display for ads and monthly price. Advertising Member can then simply select which Ad Recipient Members the Advertising Member wishes to display their ads upon by clicking an on-screen YES box.

Subsequently, the Ad Recipient Member will receive an ad display notification in the form of a communication as specified in the Ad Recipient Member's ADVERTISEMENT REVIEW/APPROVAL FORM. Note the Ad Recipient Member can receive ad display notifications communicated via e-mail, SMS message, a pop-up message which appears upon log-in to Ad Recipient Member's online account, print-out on brewer or message displayed on brewer.

Also note Advertising Members can advertise on Internet Retailer's website. Since members will repeatedly revisit Internet Retailer's website each time they wish to re-order beverages or advertising, this presents a viewing audience for the Advertising Member(s). Advertising Member(s) can purchase ad space on website to display their respective ad content (i.e. banner ad, image/logo, video, etc). Thus Internet Retailer can also receive ad content “display-requests” from Advertising Members.

Intended Ad Recipient Member reviews then approves/rejects Advertising Member's ad display request. The Advertising Member and Ad Recipient Member will share Ad Recipient ADVERTISEMENT REVIEW FORM for status (i.e. approved or rejected ads). Note that a list of pre-defined “rejection codes” will be provided so that the Advertising Member understands what changes to their respective ad are necessary, prior to the Ad Recipient Member approving the ad. Members will have a hyperlink provided which loads the rejection code webpage. Internet Retailer downloads ad content to Ad Recipient Member's brewer. In one embodiment, downloading only occurs after the Ad Recipient Member has approved the Advertising Member's ad content.

Internet Retailer bills Advertising Member and pays fee to Ad Recipient Member. Internet Retailer bills Advertising Member according to the Ad Recipient Member's published advertising rate. Internet Retailer then deducts and retains applicable fees and commissions previously agreed upon by Ad Recipient Member and then subsequently pays Ad Recipient Member the balance of collected advertising fee/payment.

Methodology for generating revenue from Business Solution Provider referrals and ad listings. The Methodology of referring third party Business Solution Providers describes a process which facilitates accomplishing key objectives for two primary audiences. For the Internet Retailer, the Methodology provides effortless recurring revenue from ongoing referral fees paid by third party business solution providers. For third party Business Solution Providers (BSP's), the Methodology provides a means for BSP's to sell their respective business services to a new market (e.g., other members of the network).

Retailer creates membership website and invites members to enroll. The page welcomes the visitor, provides a brief introduction of the Internet Retailer's company, and then invites the visitor to enroll in the Internet Retailer's “coffee club program”. The benefits of enrolling are introduction and access to money-saving subscription-based business application software.

In one embodiment, the only enrollment requirement is visitors must provide basic demographic data describing their office location (i.e. Name of business, Office location address, Company website, Products/Services sold at the location, Number of males working at location, Number of females working at location, Main contact's name, Main contact's title, Main contact's phone number and Main contact's e-mail address). Visitors must also indicate how many brewers they operate in their office and if large screen displays will be attached to the brewer. Informing prospective advertisers large screen displays will be used will potentially attract higher advertising fees.

Internet Retailer invites members to enroll (via e-mail, newspaper, etc.). Internet Retailer invites business owners to visit the website and subscribe to the “coffee club program.” The invitation can take the form of e-mail, newspaper, radio, business publications, introduced at tradeshows, etc. The invitation welcomes the prospective new members by introducing the prospective member to the Internet Retailer's company and then invites the prospective member to enroll in the Internet Retailer's “coffee club program”.

By joining, the members receive the following benefits: introduction and access to money-saving subscription-based business application software. Traditional business application software usually requires a capital investment (e.g., computers, storage media, backup systems, etc) and technical services (e.g., software maintenance, backup, etc). However the Online Business Solutions being offered by Internet Retailer require no capital investment nor need for technical services. Instead, members can rent the business application software for a low per-employee monthly fee.

In one embodiment, member receives Internet Retailer's invitation and decides whether to enroll. In one embodiment, the member enrolls and provides Internet Retailer their new Member's business profile. Providing the member provides their profile information. This information is important because members interested in advertising their respective products and services can target market by using specific demographic information provided by other members. This is the same approach used by social networking and dating websites when members conduct searches.

New members will be prompted to provide the following demographic data which describes each of their office locations: Name of enrolling member's business; Mailing address of enrolling member's business; Company website of enrolling member's business; Primary products/services sold by enrolling member's business; Number of male employees working at enrolling member's business location; Number of female employees working at enrolling member's business location; Main contact's name; Main contact's title; Main contact's phone number; Main contact's e-mail address; How many beverage brews will the enrolling member operate; and How many (if any) external screen displays will be connected to the brewer(s).

Informing prospective advertisers that a member has large screen displays can be an incentive to attract more advertising revenue.

Retailer selects Online Business Solutions Providers (BSPs) which Retailer would like to refer its members and subsequently collect a resulting referral fee. In one embodiment, retailer selects Online Business Solutions Providers (BSPs) which Retailer would like to refer members and subsequently collect a resulting fee.

BSP's may include, but are not limited to payroll service providers (i.e. ADP, Paychex, Valiant, etc.); Time and Attendance service providers (i.e. SaasHR, Swipeclock, Datamatics, etc.); Customer Relationship Management service providers (i.e. Netsuite, Saleslogix.com); Collaboration & web meeting service providers (i.e. Go-To-Meeting, etc).

The BSP's will pay a referral fee/commission to Retailer according to BSP's referral partner programs.

BSP enrolls Retailer in BSP's referral partner program. BSP enrolls Internet Retailer in BSP's referral partner program. Referral program details all terms and conditions, including referral-fee payment schedule. These BSP's normally offer subscribers (e.g., Internet Retailer's members) a one year business contracts priced per month per-employee. The resulting referral fees are normally paid to referring partners (e.g., Internet Retailer) based on a fixed percentage of the monthly fee collected by the BSP.

BSP creates a special log-in page exclusively for Retailer's members. In one embodiment, the BSP will create a special log-in page on BSP's website, exclusively for Internet Retailer members visiting. Upon arriving at the BSP's website the Internet Retailer's members will be immediately prompted for their Internet Retailer member ID number. Entering their member ID number entitles the Internet Retailer member to a discount on BSP's services, while also registering the visit as an “Internet Retailer referral”. The Internet Retailer member can then visit the site and decide whether or not to purchase the respective BSP's services.

Internet Retailer posts BSP's hyper-links on Internet Retailer's website. In one embodiment, the Internet Retailer posts BSP's hyper-links on Internet Retailer's website. These links bring the Internet Retailer members to BSP's special log-in screen designed exclusively for Internet Retailer members. The Internet Retailer may be able to derive ad fees paid by the respective BSP for members simply “clicking on” the BSP's hyper-link. This is commonly referred to as “Click-through” Marketing and is a main source of income for Internet-based companies.

Member sees BSP hyper-link and visit BSP's website. In one embodiment, first decision Member sees BSP link and decides to click on the link which subsequently brings the member to BSP's website and log-in page. Upon arriving at the BSP's website the Internet Retailer's members will be immediately prompted for their Internet Retailer member ID number. Entering their member ID number entitles the Internet Retailer member to a discount on BSP's services, while also registering the visit as an “Internet Retailer referral”. The Internet Retailer member can then visit the site and decide whether or not to purchase the respective BSP's services.

Based on the BSP's “referral partner program” terms and conditions, the Internet Retailer may be eligible for compensation based on the member's “click-through” and/or subsequent purchase of BSP's software/services.

Retailer receives notification from BSP of Internet member site visit. In one embodiment, Internet Retailer receives notification from BSP of Internet member site visit. Method and frequency of notification will be provided in BSP's “referral partner program” terms and conditions. It is assumed e-mail will be the preferred method of communication.

BSP pays Retailer's referral fee based on terms and conditions of BSP's referral partner program. The BSP then pays Internet Retailer a referral fee based on terms and conditions of BSP's referral partner program.

In one embodiment, it is necessary to order the brewer and the pre-brewed beverages from the same retailer, and enrolling brewer-users on the brewer since brewer will not operate if users cannot be identified.

In one embodiment, it is optional to use the brewer's advertising capabilities.

The coffee brewer system disclosed herein preferably lessens the cost of broadcast marketing and helps advertisers to more effectively target market their audience. While the methodology is an improvement, advertisers can still utilize television, radio, print media and online advertising to reach their intended audiences.

In one embodiment, the system may be used as an employee time clock. In one embodiment, the system can help business owners save money by automating the collection of employee time records (hours-worked) which are needed to produce the payroll. The American Payroll Association (APA) estimates that automating employee-time record collection can reduce a company's payroll expense by up to 10%. Business owners purchasing time and attendance software need a way to input employee time-records into the software so they can calculate how many hours their respective employees have worked. This information is then used to subsequently produce the payroll. Not using some type of employee time clock means employees and/or bookkeepers have to manually record each time slip by hand. But manual entry is error-prone and can lead to costly mistakes. Additionally, manually producing time records requires much more time, hence, adding more cost to producing the payroll. On the contrary, using the brewer system disclosed herein as a biometric time and attendance recorder automates payroll and saves money.

In one embodiment, the system provides a benefit as a fingerprint and face recognition system. By forcing employees to punch in/out of the system with his/her finger (or face), employees cannot cheat by punching in for each other. Employees who fraudulently punch in and out for each other are committing “buddy-punching” which is actually “time theft” (getting paid when not working). Buddy punching is well known in the Labor Management industry and it is a major expense. Deploying biometric time recorders eliminates buddy punching.

Health Clubs. The system disclosed herein can protect membership fee/revenue. When health clubs sign up members, an ID card is typically created for the member (and only that member) to gain rightful access to the club. But it is quite easy for the paying member to “lend” their card to a non-paying member who wishes to enjoy free access to the health club. And since the front desk is usually swamped with members trying to get in, non-members easily bypass the desk undetected. This means lost revenue to the health club owner. By using fingerprint and/or recognition instead of ID cards, only members who have enrolled his/her respective fingerprint or face in the health club's computers can gain access to the club. Cards are eliminated and membership revenue is protected. Fingerprint recognition technology is also much more convenient for members, since members no longer have to remember bringing their card.

The world's largest privately held health club with over 3 million members and 400 clubs in the U.S. (24 Hour Fitness) recently implemented biometrics to address the aforementioned concerns. When placed at the health club's front desk or at the entrance of an aerobics room or spin/cycling classroom, each brewer system may be used to record a health club member's attendance.

Members can sign up in advance, and rightfully secure the use of a piece of equipment (e.g., a treadmill) or standing position in an aerobics class. Each brewer system maintains an “audit trail” of each member's attendance. This audit trail can be submitted to the respective member's health insurance provider, thus possibly lowering the insurance premiums for that member since some insurance companies reward subscribers practicing “preventative healthcare maintenance”. The respective member's employer may also see a reduction in premiums as a result of the member's frequent visiting of a health club. If the health insurance premium reductions are significant, the health club owners may consider marketing the “audit trail” capability as a way to lower membership fees, thus increasing enrollment.

Surrounding nearby vendors and health product manufacturers can advertise their respective products. Additionally, the system can be programmed to send SMS coupons for various hair products to the patients' cell phone (or to a printer). In addition to outside vendors advertising, the health club owners can also advertise or announce class schedules, promotions, fitness contests . . . or create messages specific to certain members (e.g., “Your membership is up for renewal in two weeks. Please see an enrollment advisor”).

With the system's interactive touch-screen, members can also pre-order snacks and refreshments at the club's Juice Bar/Food counter. If a member knows his/her 30-minute exercise class ends at 7:30 pm, they can have a refreshing pre-brewed beverage prepared and waiting for them at 7:35 pm. No more waiting in line suffering from thirst. And if the system is connected with the respective member's credit card used to activate their enrollment at the club, the member can simply use their fingerprint and have the club automatically debit their account. Utilizing fingerprint recognition technology eliminates the need to carry around money in the club.

The system can be used is cafeterias. Implementing biometric identification means no longer needing to carry money when purchasing food items or pre-brewed beverages. Schools often have financial accounts for students, from which pre-paid funds are used to purchase books, meals, etc. Normally an ID card must be issued to identify the student. And in the public school system, meals are often subsidized by the USDA's National School Lunch Program (NSLP). The NSLP identifies low-income students qualifying for free (or subsidized meals) and issues them an ID card clearly identifying them as a low-income student. This can be embarrassing and demoralizing each time the low-income student presents his/her card. However, by implementing the system disclosed herein, the student's financial status is kept confidential and meals are secretively (and automatically) charged to their account (or withdrawn from their NSLP allowance). This type of solution has been implemented already by a company named Food Service Solutions. See http://www.foodserve.com/

In addition to automating billing and securing the privacy of the students, the system provides 2-way communication. When the student's account is low, the system can message the student; “Funds low. Please replenish.” When a teacher needs to reach a student, the system can message: “Please see Professor Jones regarding recent paper submitted.”

Schools and Health Insurance providers may also have an interest in exactly what the student is consuming. Students might be incented financially to reduce their caloric intake or choose different food groups (ex. more fruits or vegetables). The system disclosed herein can create an audit trail of what the student is ordering and report back to concerned parents or health insurance providers. And with all applications, the system constantly serves as an advertisement platform in which surrounding vendors can pay a fee and advertise their respective products and services while students/employees pass through the cafeteria line.

Bank's safe deposit/vault access. In one embodiment, bank customers wishing to secure valuable possessions in a bank's safe deposit box/vault are often issued ID cards with his/her signature. When subsequently needing access to his/her safe deposit box, the bank customer is often asked for ID and a sample of his/her signature. A good forgery artist can often unscrupulously pose as the legitimate safe deposit owner, and gain unlawful access. However, by implementing biometric technology, only banking customers with a matching fingerprint can rightfully gain access to his/her safe deposit box. With two way communication, the system disclosed herein can notify bank customers access his/her safe deposit box when they need to speak to a banking representative (e.g., when account is overdrawn). The bank may also run its own ads (e.g., new mortgage rates, CD rates, car loans, etc) or collect advertising fees from surrounding nearby vendors wishing to gain exposure to the bank's customers (e.g., local restaurants, salons, car washes, dry cleaner, etc.).

Movie Theaters. In one embodiment, movie-goers who frequent the same theater can enroll his/her fingerprint in an automatic billing system, such that the movie goers can retrieve movie tickets at the touch of a finger. As with the cafeteria application, movie goers will have an account set up with the theater. The theater can then automatically debit the movie goers account ever time they view a movie. The system disclosed herein can also run trailers of respective movies, or ads placed by nearby surrounding vendors. The theater's concession stand can also run ads and allow for coupons to be printed out or SMS messages to the movie goers cell phone.

In one embodiment, the movie goers (or their children) will select on the two way interactive display of the movie they will see. The movie is then recorded. The movie viewed can then be reported to the children's parents (for safety concerns) and both the theater and movie producers. The system can also send an SMS message to parents when the system dispenses a ticket to the parent's child. This ensures the child is safe, present at the theatre and viewing an appropriate movie agreed upon by the parent.

Sports/Concert Arenas. Sports/concert VIPs enjoying the comfort and convenience of Executive suites, can also enjoy greater convenience by paying for everything with their fingerprint. As with the health club Juice bar/Food stand example, implementing biometric identification means no longer needing to carry money when purchasing food items or pre-brewed beverages in the Executive Suite. The venue can have financial accounts for VIPs and their guests, from which funds are used to purchase food and pre-brewed beverages. See http://wwww.foodserve.com/.

The system may also allow VIP guests to order food and pre-brewed beverages. But in addition to automating billing and ordering food and pre-brewed beverages, the system provides two way communication. VIP guests can order transportation (e.g., a cab ride home), check train schedules, order tickets for upcoming events, etc.

And with all applications, the system disclosed herein constantly servers as an advertisement platform in which surrounding vendors can pay a fee and advertise their respective products and services while students/employees pass through the cafeteria line.

Hotel Registration. The system disclosed herein may dramatically facilitate hotel check-in process by eliminating the need for hotel guests to wait and stand in line at the front desk to obtain their room key/card. It also uniquely creates advertising revenues for hotels. Once a hotel guest finally arrives to his/her hotel after a long flight (or car drive) he/she is often forced to stand in line at the registration desk in order to obtain his/her respective room key. This is often an unpleasant experience. However, the system disclosed herein preferably allows hotel guests to access his/her hotel room with their fingerprint, instead of using the door key/card normally issued at a hotel registration desk. Hotels can remotely enroll VIP guests' fingerprints into the hotel's computer system, and then copy the fingerprints (via the Internet or LAN) no to the system which is installed on each hotel door. After a hotel guest phones the hotel and makes his/her reservation/payment, his/her hotel room door's wall-mounted system will be programmed with his/her respective fingerprint. When the hotel guest arrives at the hotel, they can proceed straight to their hotel room and bypass the entire check-in process. Once he/she arrives to his/her room, they will place his/her finger on the system. When the system recognizes the hotel guests' fingerprint, the door will release and the hotel guest will have access to his/her room. The guest's room awaits them without having to stand in line!

The system disclosed herein may be incorporated into any present-day advertisement delivery system currently using the Internet, TV or any other broad-based medium (e.g., Google, Yahoo, Verizon, Yellow pages, Cablevision, Time Warner, etc) can benefit from the invention. Moreover, any present-day hardware manufacturers providing multi-application support and can display multi-media content (ex. Dell, HP Apple Computer, etc.) can benefit from the invention.

In one embodiment, the system disclosed herein may produce an audit trail of any registered user who has made physical contact with the system. The audit trail may include the user's ID number, the day, and the time in which the user made contact with the system. This information may be very helpful in time and attendance applications

In one embodiment, the system disclosed herein may be incorporated into a mirror that displays advertising and promotions. The mirror may have touch-screen technology.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

1. A coffee brewer advertising and marketing system comprising:
a beverage brewer having a touch-screen display and at least one user-identification sensor;
a beverage cup containing a pre-brewed beverage;
a brewer lever that is lowered for piercing said beverage cup;
a pre-programmed RFID chip provided on said beverage cup;
said beverage brewer having an RF reader that reads said RFID chip embedded on said beverage cup, wherein only authorized beverages provided in approved beverage cups are dispensed by said beverage brewer.

2. The system as claimed in claim 1, further comprising communication ports for wireless connectivity to an office computer or a cell phone tower.

3. The system as claimed in claim 1, further comprising a power supply.

4. The system as claimed in claim 1, wherein said beverage brewer comprises a drinking cup holder.

5. The system as claimed in claim 1, further comprising:
a printer for printing usage receipts, vendor coupons or information;
a water heater; and
a water tank.

6. The system as claimed in claim 1, wherein said at least one user-identification sensor confirms that a user is authorized to operate said beverage brewer, and wherein said beverage brewer dispenses a brewed beverage only if said user is identified by said at least one user-identification sensor as an authorized user.

7. The system as claimed in claim 6, wherein said at least one user-identification sensor is selected from the group consisting of a fingerprint sensor, a biometric sensor, a face recognition sensor, a magnetic strip sensor, a proximity card sensor, a personal identification number (PIN) sensor, and an identification card sensor.

8. The system as claimed in claim 1, further comprising a camera for identify a user's face, wherein said beverage brewer dispenses a brewed beverage only if said user is identified by said camera as an authorized user.

9. The system as claimed in claim 6, wherein said system establishes a separate account for each of said authorized users for recording a charge each time a brewed beverage is dispensed by said beverage brewer.

10. The system as claimed in claim 9, wherein said system deducts the charges from the paychecks of said authorized users.

11. The system as claimed in claim 1, wherein said system comprises a plurality of said beverage brewers that are joined together via a network, wherein at least some of said beverage brewers are at different locations.

12. The system as claimed in claim 11, wherein said system comprises a plurality of members that are part of said network, and wherein said members utilize said beverage brewers to communicate with one another.

13. The system as claimed in claim 12, further comprising at least one video monitor associated with each of said beverage brewers.

14. The system as claimed in claim 13, wherein said network enables said members to upload commercial advertisements onto said system for displaying said commercial advertisements on said video monitors associated with said beverage brewers.

15. The system as claimed in claim 14, wherein said network enables said members to collect revenue for running said commercial advertisements of said video monitors associated with said beverage brewers provided at member locations.

16. A coffee brewer advertising and marketing system comprising:
a beverage brewer having a touch-screen display and at least one user-identification sensor;
a beverage cup containing a pre-brewed beverage;
a pre-programmed RFID chip provided on said beverage cup;
said beverage brewer having an RF reader that reads said RFID chip embedded on said beverage cup, wherein only authorized beverages provided in approved beverage cups are dispensed by said beverage brewer;
at least one user-identification sensor for confirming that a user is authorized to operate said beverage brewer, wherein said beverage brewer dispenses a brewed beverage only if said user is identified by said at least one user-identification sensor as an authorized user.

17. The system as claimed in claim 16, further comprising a printer for printing usage receipts, vendor coupons or information for said users.

18. The system as claimed in claim 16, wherein said at least one user-identification sensor is selected from the group consisting of a fingerprint sensor, a biometric sensor, a face recognition sensor, a magnetic strip sensor, a proximity card sensor, a personal identification number (PIN) sensor, and an identification card sensor.

19. The system as claimed in claim 16, further comprising a camera for identify a user's face, wherein said beverage brewer dispenses a brewed beverage only if said user is identified by said camera as an authorized user.

20. The system as claimed in claim 16, wherein said system establishes a separate account for each of said authorized users for recording a charge each time a brewed beverage is dispensed by said beverage brewer, and wherein said system deducts the charges for said brewed beverages said separate account of each said authorized user.
